(19) United States
(12) Patent Application Publication
(10) Pub. No.: US 2024/0264722 A1
(43) Pub. Date: Aug. 8, 2024

(54) User Interface Enabling Interactive feedback

(71) Applicant: Monday.com Ltd., Tel Aviv (IL)

(72) Inventors: Inbal GERY, Tel Aviv-Yafo (IL); Hanna SOKOLOV, Ramat Gan (IL)

(21) Appl. No.: 18/106,089

(22) Filed: Feb. 6, 2023

(51) Int. Cl. G06F 3/0484; G06F 3/04812; G06F 3/0482

(52) U.S. Cl. CPC G06F 3/0484; G06F 3/04812; G06F 3/0482

(57) ABSTRACT

There are provided systems and methods comprising, for a user interface that comprises a plurality of interactive elements comprising a first interactive element and a second interactive element, executing: responsive to detecting valid user interaction with the first interactive element, triggering display of a visual representation on at least one of the first interactive element or the second interactive element, wherein the visual representation provides, to a user, indication of a location in the user interface of the second interactive element with which a user interaction is required, thereby providing feedback to the user while interacting with the user interface.

### FIELD

The presently disclosed subject matter relates to the field of user interfaces.

### BACKGROUND

A user interface (also known as a graphical user interface—GUI) allows a user to interact with an electronic device through graphical elements. A user interface allows a user to access, modify, and/or control operation of the electronic device. In particular, the user may interact with a user interface by entering various data and/or clicking on icons on the user interface. The electronic device can be configured to execute various operations in response to user input received through the user interface. For example, computer programs being executed by a computer device can be accessed, controlled, and modified by a user using a user interface.

### GENERAL DESCRIPTION

In accordance with certain aspects of the presently disclosed subject matter, there is provided a computer-implemented method applicable in a user interface that comprises a plurality of interactive elements comprising a first interactive element and a second interactive element, comprising: responsive to detecting valid user interaction with the first interactive element, triggering display of a visual representation on at least one of the first interactive element or the second interactive element, wherein the visual representation provides, to a user, indication of a location in the user interface of the second interactive element with which a user interaction is required, thereby providing feedback to the user while interacting with the user interface.

According to some examples, before display of the visual representation, the first interactive element and the second interactive element are both already visible to the user in the user interface.

According to some examples, the first interactive element is associated with the second interactive element by at least one property related to the user interface, wherein a type of the visual representation is indicative of said property.

According to some examples, the first interactive element is associated with the second interactive element by at least one property related to the user interface.

According to some examples, this property corresponds to the fact that a position of the first interactive element and a position of the second interactive element meet a proximity criterion.

According to some examples, this property corresponds to the fact that a content associated with the first interactive element and a content associated with the second interactive element are linked.

According to some examples, this property corresponds to the fact that there is a required order of interaction between the first interactive element and the second interactive element.

According to some examples, the first interactive element is an input window, and the second interactive element is a clickable element, wherein interaction with the first interactive element includes text input and valid user interaction includes input of text that complies with a certain condition.

According to some examples, the first interactive element is a first input window enabling text input, and the second interactive element is a second input window enabling text input, wherein valid user interaction with the first interactive element includes input of text that complies with a certain condition.

According to some examples, the valid user interaction with the first interactive element is detected automatically as the user is providing a text input, without requiring the user to interact with a clickable element after performing said valid user interaction.

According to some examples, display of the visual representation is triggered immediately after detecting the valid user interaction with the first interactive element.

According to some examples, the visual representation includes a visual animation which is characterized, at least partially, by a directional motion along a direction which depends on a position of the second interactive element relative to the first interactive element on the user interface.

According to some examples, the method comprises dynamically determining the position of the second interactive element with respect to the first interactive element and adapting the direction of the visual representation accordingly.

According to some examples, dynamically determining the position of the second interactive element with respect to the first interactive element, and adapting the direction of the visual representation accordingly, is performed responsive to an event that triggers the change of the position of the second interactive element with respect to the first interactive element.

According to some examples, the method comprises, responsive to detecting valid user interaction with the first interactive element, switching the second interactive element from an inactive state to an active state, wherein the switching occurs after an end of the display of the visual representation.

According to some examples, during at least part of a motion of the visual representation, said visual representation moves in a direction oriented from the first interactive element towards the second interactive element.

According to some examples, once a position of the visual representation reaches a certain area within the second interactive element, the visual representation modifies an appearance of the second interactive element.

According to some examples, once a position of the visual representation has reached a certain area within the second interactive element, the visual representation converges and moves over the second interactive element.

According to some examples, the visual representation includes modifying an appearance of a contour of the first interactive element or of the second interactive element.

According to some examples, the method comprises maintaining a display of the visual representation until an interaction with the second interactive element by the user has been detected.

According to some examples, responsive to detecting valid user interaction with the first interactive element, the method comprises triggering display of a visual representation indicative of the second interactive element and of a third interactive element of the plurality of interactive elements, wherein both the second interactive element and the third interactive element are each associated with the first interactive element by at least one property related to the user interface, wherein the visual representation is displayed on at least one of the first interactive element, or the second interactive element, or the third interactive element.

According to some examples, before display of the visual representation, the second interactive element is not visible in the user interface to the user, wherein triggering display of the visual representation comprises performing one or more changes to the user interface, which provides an indication to the user of the location of the second interactive element off screen.

In accordance with other aspects of the presently disclosed subject matter, there is provided a system comprising a processor and memory circuitry (PMC), wherein, for a user interface that comprises a plurality of interactive elements comprising a first interactive element and a second interactive element, the PMC is configured to execute: responsive to detecting valid user interaction with the first interactive element, triggering display of a visual representation on at least one of the first interactive element or the second interactive element, wherein the visual representation provides, to a user, indication of a location in the user interface of the second interactive element with which a user interaction is required, thereby providing feedback to the user while interacting with the user interface.

In accordance with other aspects of the presently disclosed subject matter, there is provided a non-transitory computer readable medium comprising instructions that, when executed by a processor and memory circuitry (PMC), cause the PMC to perform operations comprising, for a user interface that comprises a plurality of interactive elements comprising a first interactive element and a second interactive element: responsive to detecting valid user interaction with the first interactive element, triggering display of a visual representation on at least one of the first interactive element or the second interactive element, wherein the visual representation provides, to a user, indication of a location in the user interface of the second interactive element with which a user interaction is required, thereby providing feedback to the user while interacting with the user interface.

According to some examples, the proposed solution facilitates user interaction with a user interface, by providing visual feedback to the user during interaction with the user interface.

According to some examples, the time required by a user to complete interaction with the user interface is reduced.

According to some examples, the proposed solution improves the user experience, thereby increasing the number of users willing to interact with the user interface.

According to some examples, the proposed solution provides dynamic feedback which depends on the action(s) of the user.

According to some examples, the proposed solution provides smart and customized feedback to the user, which facilitates interaction with the user interface.

According to some examples, the proposed solution provides feedback which is “context induced”, meaning that it provides an indication of different interactive elements which have some type of contextual relation.

According to some examples, the proposed solution is flexible and adapts to various types of user interfaces, such as forms, tables, emails, etc.

According to some examples, the proposed solution provides feedback in real time or quasi real time, in response to data provided by the user in the user interface.

According to some examples, the proposed solution provides automatic feedback to the user in the user interface, without requiring the user to actively trigger this feedback.

### BRIEF DESCRIPTION OF THE DRAWINGS

In order to understand the invention and to see how it can be carried out in practice, embodiments will be described, by way of non-limiting examples, with reference to the accompanying drawings.

FIG. 1 illustrates a system which can be used to perform one or more of the methods described hereinafter, according to examples of the presently disclosed subject matter.

FIG. 2A illustrates a method of providing interactive feedback to a user in a user interface, according to examples of the presently disclosed subject matter.

FIG. 2B illustrates a non-limitative example of a user interface.

FIG. 2C illustrates a method of determining valid user interaction with an interactive element, according to examples of the presently disclosed subject matter.

FIG. 2D illustrates examples of data which can be used and/or generated in the method of FIG. 2C.

FIG. 3A illustrates another non-limitative example of a user interface.

FIGS. 3B and 3C illustrate usage of the method of FIG. 2A in the user interface of FIG. 3A, according to examples of the presently disclosed subject matter.

FIG. 4A illustrates another method of providing interactive feedback to a user in a user interface, according to examples of the presently disclosed subject matter.

FIG. 4B illustrates a non-limitative example of usage of the method of FIG. 4A in a user interface.

FIG. 4C illustrates another non-limitative example of usage of the method of FIG. 4A in a user interface.

FIG. 4D illustrates another non-limitative example of usage of the method of FIG. 4A in a user interface.

FIG. 4E illustrates another non-limitative example of usage of the method of FIG. 4A in a user interface.

FIG. 5A illustrates another method of providing interactive feedback to a user in a user interface, according to examples of the presently disclosed subject matter.

FIG. 5B illustrates a non-limitative example of the method of FIG. 5A.

FIGS. 5C to 5I illustrate a non-limitative example of usage of the methods of FIGS. 5A and 5B in a user interface.

FIGS. 6A and 6B illustrate another non-limitative example of usage of the methods of FIGS. 5A and 5B in a user interface.

FIGS. 6C and 6D illustrate another non-limitative example of usage of the method of FIGS. 5A and 5B in a user interface.

FIG. 6E illustrates another non-limitative example of usage of the methods of FIGS. 5A and 5B in a user interface.

FIG. 6F illustrates another non-limitative example of usage of the method of FIGS. 5A and 5B in a user interface.

FIG. 7A illustrates another method of providing interactive feedback to a user in a user interface.

FIGS. 7B and 7C illustrate a non-limitative example of usage of the method of FIG. 7A in a user interface.

FIG. 8 illustrates another method of providing interactive feedback to a user in a user interface, according to examples of the presently disclosed subject matter.

FIGS. 9A and 9B illustrate non-limitative examples of visual representations which can be used to provide interactive feedback to a user.

FIG. 10A illustrates a method of providing interactive feedback to a user in a user interface, according to examples of the presently disclosed subject matter.

FIGS. 10B to 10D illustrate non-limitative examples of usage of the method of FIG. 10A in a user interface.

FIG. 11 illustrates a method of providing interactive feedback to a user in a user interface, according to examples of the presently disclosed subject matter.

FIG. 12 illustrates a non-limitative example of visual representation which can be used to provide interactive feedback to a user.

### DETAILED DESCRIPTION OF EMBODIMENTS

In the drawings and descriptions set forth, identical reference numerals indicate those components that are common to different embodiments or configurations. Elements in the drawings are not necessarily drawn to scale.

In the following detailed description, numerous specific details are set forth in order to provide a thorough understanding of the invention. However, it will be understood by those skilled in the art that the presently disclosed subject matter may be practiced without these specific details. In other instances, well-known methods have not been described in detail so as not to obscure the presently disclosed subject matter.

Unless specifically stated otherwise, as apparent from the following discussions, it is appreciated that throughout the specification, discussions utilizing terms such as “executing”, “triggering”, “providing”, “detecting”, “determining”, “adapting”, “switching”, “modifying”, “displaying”, “performing”, or the like, refer to the action(s) and/or process(es) of a computer that manipulate and/or transform data into other data, said data represented as physical, such as electronic, quantities and/or said data representing the physical objects.

The terms “computer” or “computerized device” should be expansively construed to include any kind of hardware-based electronic device with a data processing circuitry (e.g., digital signal processor (DSP), a GPU, a TPU, a field programmable gate array (FPGA), an application specific integrated circuit (ASIC), microcontroller, microprocessor etc.). The data processing circuitry (designated hereinafter as processor and memory circuitry) can comprise, for example, one or more processors operatively connected to computer memory, loaded with executable instructions for executing operations, as further described below. The data processing circuitry encompasses a single processor or multiple processors, which may be located in the same geographical zone, or may, at least partially, be located in different zones, and may be able to communicate together.

Operations in accordance with the teachings herein may be performed by a computer or computerized device specially constructed for the desired purposes, or by a general-purpose computer or computerized device specially configured for the desired purpose by a computer program stored in a computer readable storage medium.

As used herein, the phrase “for example”, “such as”, and variants thereof, describe non-limiting embodiments of the presently disclosed subject matter. Reference in the specification to “one example”, “some examples”, “other examples”, or variants thereof, means that a particular feature, structure, or characteristic, described in connection with the embodiment(s), is included in at least one embodiment of the presently disclosed subject matter. Thus, the appearance of the phrase “one example”, “some examples”, “other examples”, or variants thereof, does not necessarily refer to the same embodiment(s).

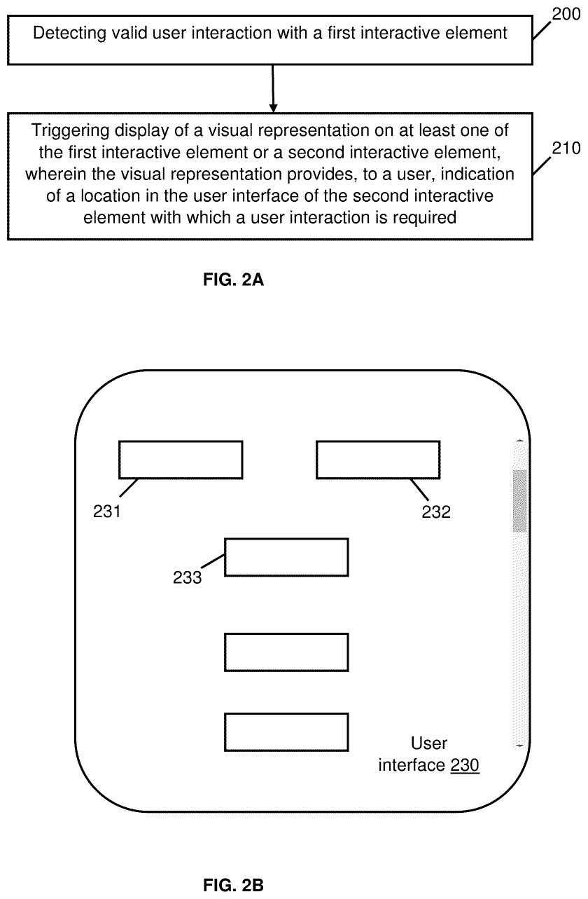

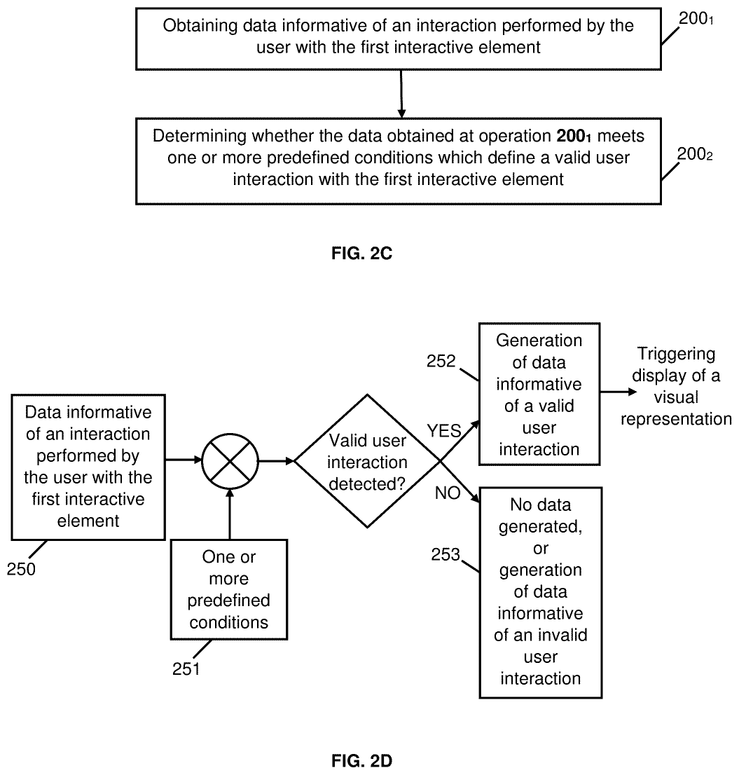

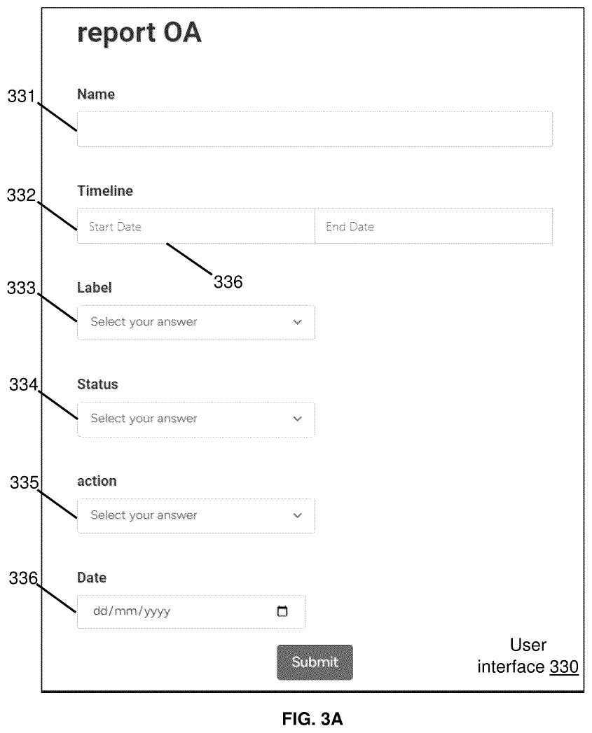

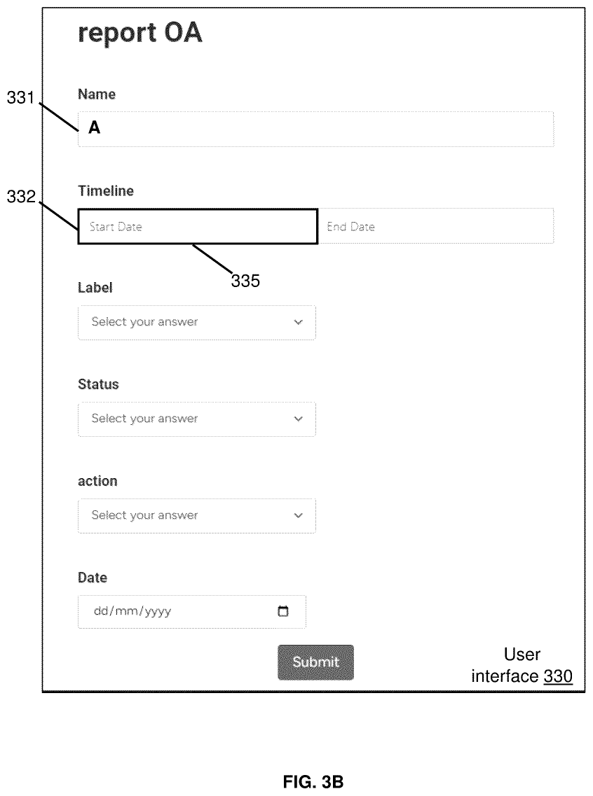

In embodiments of the presently disclosed subject matter, fewer, more, and/or different stages than those shown in the methods of FIGS. 2A, 2C, 2D, 4A, 5A, 5B, 7A, 8, 10A and 11 may be executed. In embodiments of the presently disclosed subject matter, one or more stages illustrated in the methods of FIGS. 2A, 2C, 2D, 4A, 5A, 5B, 7A, 8, 10A and 11 may be executed in a different order, and/or one or more groups of stages may be executed simultaneously.

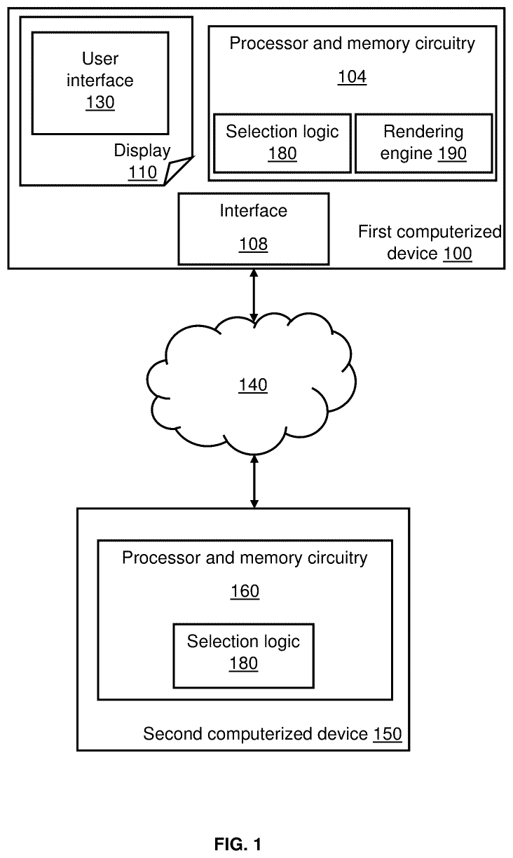

Attention is now drawn to FIG. 1, which depicts a computerized system capable of executing the methods described with reference to FIGS. 2A, 2C, 2D, 4A, 5A, 5B, 7A, 8, 10A and 11, according to some examples of the presently disclosed subject matter. In particular, the computerized system of FIG. 1 can be used to display a user interface to a user, and to provide interactive feedback to the user, as explained with reference to the various methods described hereinafter.

Elements of the system depicted in FIG. 1 can be made up of any combination of software and hardware and/or firmware. Elements of the system depicted in FIG. 1 may be centralized in one location or dispersed over more than one location. In other examples of the presently disclosed subject matter, the system of FIG. 1 may comprise fewer, more, and/or different elements than those shown in FIG. 1. Likewise, the specific division of the functionality of the disclosed system to specific parts, as described below, is provided by way of example, and other various alternatives are also construed within the scope of the presently disclosed subject matter.

More particularly, FIG. 1 schematically depicts an example of a first computerized device 100, with which a user can interact. The first computerized device 100 corresponds for example to a computer, a cellular phone such as a smartphone, a tablet, a server, a smartwatch, etc. These examples are not limitative.

The first computerized device 100 includes at least one processor and memory circuitry (PMC) 104 enabling data processing. PMC 104 includes at least one processor (not shown separately) and a computer memory (not shown separately).

The first computerized device 100 can include a display 110 (e.g., a screen) which enables displaying data to the user. In particular, the display 110 can display a user interface 130 to the user. In some examples, the first computerized device 100 can include a sound speaker enabling outputting audio data.

The first computerized device 100 includes an interface 108 enabling the user to interact with the user interface 130 displayed on the display 110. For example, the interface 108 includes a keyboard and/or a mouse and/or a tactile screen, etc.

In some examples, the first computerized device 100 can exchange data, through a communication link 140 (network such as Internet, Intranet, cellular network, Wi-Fi data link, Bluetooth data link, NFC data link, etc.), with at least one second computerized device 150 (different from the first computerized device 100).

The second computerized device 150 includes at least one processor and memory circuitry (PMC) 160 enabling data processing. PMC 160 includes at least one processor (not shown separately) and a memory (not shown separately).

In some examples, the second computerized device 150 corresponds to a server. In some examples, the second computerized device 150 corresponds to a cloud server (or to a plurality of cloud servers).

In some examples, display of the user interface 130 can be handled by PMC 104, or by PMC 160, or by both of them.

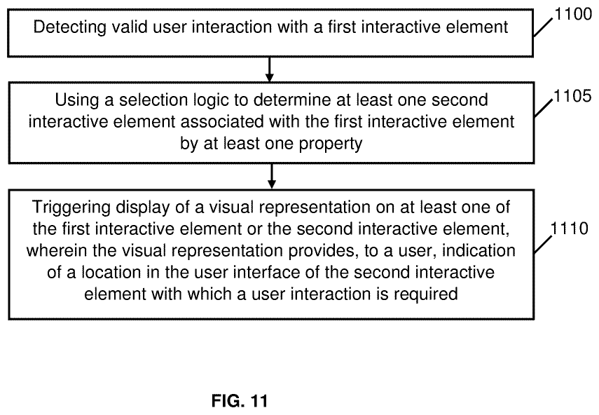

According to some examples, PMC 104 and/or PMC 160 implements a selection logic 180. The selection logic 180 includes computer-executable instructions, which, when executed by the PMC 104 and/or the PMC 160, enable the PMC 104 and/or the PMC 160 to perform a selection in the user interface. The nature of this selection will be described hereinafter, in particular with reference to FIG. 11.

In some examples, the selection logic 180 is stored in a memory which is not necessarily the memory of PMC 104 and/or of PMC 160, but which can be accessed by PMC 104 and/or PMC 160.

According to some examples, PMC 104 can implement a rendering engine 190. The rendering engine 190 includes computer-executable instructions, which, when executed by PMC 104, enable processing of data defining a user interface (such as content of the user interface, formatting information associated with the user interface, and visual representation(s)/animation(s) associated with the user interface). The rendered content can be displayed on the display 110 of the first computerized device 100. In some examples, the rendering engine 190 is a software component of a web browser (not represented), which can be implemented by PMC 104.

Various methods are described hereinafter which are associated with the display of a user interface to a user. According to some examples, these methods can be performed by PMC 104, or by PMC 160, or by both PMC 104 and PMC 160, where tasks can be split between PMC 104 and PMC 160. According to some examples, at least some of the tasks of the various methods described hereinafter can be performed by a PMC of a third-party computerized device, which is different from the first computerized device 100 and from the second computerized device 150.

Attention is now drawn to FIGS. 2A and 2B. FIG. 2A is a high-level flowchart of a method of providing interactive feedback to a user interacting with a user interface according to examples of the presently disclosed subject matter. FIG. 2B depicts an example of a user interface 230 displayed to a user using the first computerized device 100, on which the method of FIG. 2A can be applied.

The user interface 230 includes a plurality of interactive elements (see e.g., first interactive element 231, second interactive element 232, third interactive element 233, etc.). Note that the number of interactive elements is between 2 and N, with N an integer greater than 2.

In some examples, only a portion of the user interface 230 is displayed on the display 110 of the first computerized device 100. As a consequence, only a fraction of the interactive elements of the user interface 230 is visible simultaneously on the display 110. In order to display the other portion(s) of the user interface 230, the user may be required to perform an action, such as scrolling and/or performing a zoom-out.

In some examples, the whole user interface 230 is displayed on the display 110 of the first computerized device 100.

An interactive element is an element of the user interface 230 with which the user can interact. An example of an interactive element can include an input window enabling text input, such as a cell for entering strings of characters (e.g., email address), numbers (e.g., phone number), or a combination of both (e.g., an address). Further examples can include a scrolling menu, in which there are predetermined options for a user to choose from, a clickable button (e.g., validation button), an operable element/script enabling uploading of a file, etc.

Implementation of an interactive element (by PMC 104 and/or by PMC 106) can rely for example on the usage of Document Object Model (“DOM”—which is a cross-platform and language-independent interface that treats an XML or HTML document as a tree structure, wherein each node is an object representing a part of the document), or other adapted object-oriented representations. This enables defining the various properties of the interactive element, such as its graphical properties and the method(s) according to which a user may interact with the interactive element, and the like.

The method illustrated in FIG. 2A will now be described. This method can be used to provide interactive feedback to a user interacting with a user interface including a plurality of interactive elements. The method can be configured to provide visual guidance to a user through its interactions with the displayed interactive elements. In particular, the visual guidance can be dedicated for assisting the user in his interaction with the user interface, by drawing the user's attention to the next interactive element(s) (designated in FIG. 2A as second interactive element(s)) with which the user should interact. The user is therefore guided dynamically between two or more interactive elements on the user interface by the visual guidance which is displayed in response to his interaction with one or more interactive elements (designated in FIG. 2A as first interactive element(s)). In particular, the visual guidance can provide, to the user, indication of a location in the user interface of the next interactive element(s) (designated in FIG. 2A as second interactive element(s)) with which a user interaction is required. In some examples, the visual guidance can provide indication on successful fulfillment of interaction(s) of the user with one or more interactive elements, to encourage the user to continue interacting with the next interactive element(s).

Note that the user can be guided by the visual guidance towards the next interactive element(s) which can be selected by PMC 104 and/or PMC 160 based on the selection logic 180 (shown in FIG. 1). As explained hereinafter with reference to FIG. 11, the selection logic 180 enables PMC 104 and/or PMC 160 to select the next interactive element(s) of the user interface which is (are) associated with the first interactive element by at least one property (or a plurality of properties). Examples of properties include e.g. a required order of interaction between the first interactive element and the next interactive element(s), a predefined relationship between a position of the first interactive element and the position of the next interactive element(s), a similarity between a graphical property of the first interactive element and a graphical property of the next interactive element(s), a relation between the first interactive element and the next interactive element(s), based on the content of the first interactive element and the content of the next interactive element(s), etc.

A non-limitative example of a user interface 230 on which the method of FIG. 2A can be used is provided with reference to FIG. 2B. The plurality of interactive elements of the user interface includes at least a first interactive element and a second interactive element (see e.g., first interactive element 231 and second interactive element 232 of the user interface 230 in FIG. 2B).

In order to provide visual guidance as explained above, the method described with reference to FIG. 2A includes (operation 200) detecting valid user interaction with the first interactive element of the user interface (see e.g., first interactive element 231 of the user interface 230). Note that the validity of the user interaction may depend on the type of user interaction enabled by the first interactive element. Non-limitative examples of detecting valid user interaction in accordance with operation 200 will be described with reference to FIGS. 2C and 2D.

In response to detection of a valid interaction with the first interactive element (operation 200), the method of FIG. 2A further includes triggering (operation 210) display of a visual representation. The visual representation can be displayed on the first interactive element, the second interactive element, or on both the first and second interactive elements. In some examples, the visual representation can be displayed on additional interactive element(s) of the user interface, different from the first and second interactive elements. When a visual representation is displayed on a plurality of interactive elements of the user interface, the visual representation can occur on the plurality of interactive elements in a predetermined order, in an order determined by the order of interactions of the user, or simultaneously.

The visual representation can include display of one or more graphical elements superimposed on the user interface. In some examples, the visual representation can include an animation including one or more graphical elements changing over time. For example, their position and/or their type and/or their number and/or their graphical parameters (color, dimensions, etc.) can evolve over time (during at least part of, or for the entire duration of the animation).

According to some examples, the visual representation can be defined as a property of the interactive element (e.g., first interactive element and/or second interactive element) on which it is displayed.

According to some examples, the visual representation can be defined as a property of the user interface.

According to some examples, the visual representation can be defined as a property of a computer-implemented software which acts as an add-on or extension of the user interface.

Assume that triggering of the display of the visual representation (in accordance with operation 210 of FIG. 2A) occurs at time t₁. The visual representation can be displayed over a given period of time, e.g. from time t₁ to time t₂. In some examples, the duration of the given period of time (|t₂−t₁| in this example) is predefined and can be stored as a property of the visual representation in a computer memory. In other examples, the duration of the given period of time can depend on one or more interactions of the user with interactive element(s) of the user interface. For example, when the user selects the second interactive element(s), this selection can be used to define the end of the given period of time, which corresponds to time t₂. This example is not limitative.

In some examples, the visual representation does not change in the given period of time (from time t₁ to time t₂). In some examples, after time t₂, the visual representation can disappear from the user interface.

In other examples, the visual representation can include one or more graphical components which change over at least part of the given period of time (from time t₁ to time t₂). For example, the visual representation can include a graphical component (e.g., animation) which has one or more graphical properties which change over at least part of the given period of time. Note that in some examples, an animation which repeats itself at least once can be displayed in the given period of time (from time t₁ to time t₂). In some examples, after the end of the given period of time (at time t₂), the graphical component can disappear from the user interface. In other examples, after the end of the given period of time (at time t₂), a static visual representation can be displayed, which does not change over time.

In some examples, one or more interactive elements of the user interface can be associated with an activated property (defined e.g., as part of a DOM), which is configured to switch between at least two states including an active state and an inactive state. In the active state of a given interactive element, in response to a valid user interaction of the user with the given interactive element, at least one action associated with the given interactive element is triggered. In the inactive state, even if the user performs a valid user interaction with the given interactive element, the at least one action associated with the given interactive element is not triggered. Note that it is also possible to define under which conditions the given interactive element should switch from the active state to the inactive state, or vice versa. In some cases, one or more graphic properties of the interactive element can be changed, depending on its current state (active state, inactive state).

For example, assume that the given interactive element is an input window enabling text input. In the active state, the user can click on the input window and enter text. In the inactive state, the user cannot click on the input window to enter text. Likewise, if the interactive element is a clickable button, in the active state, upon detection of user click on the clickable button, an action associated with the clickable button is triggered, such as opening of a new window, loading of a webpage, opening of a scrolling menu enabling user selection among different options, transmission of data entered in the user interface to a second computerized device 150, etc. In the inactive state, even if the user clicks on the clickable button, the action is not triggered.

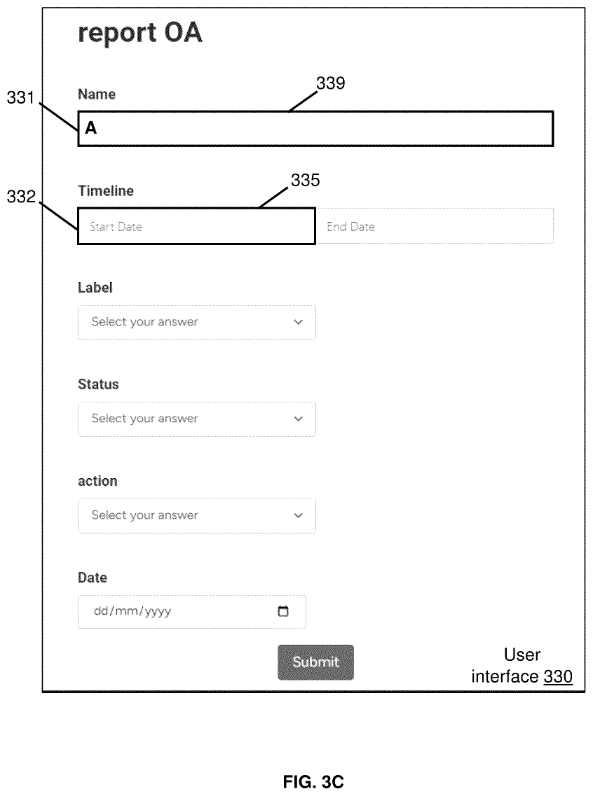

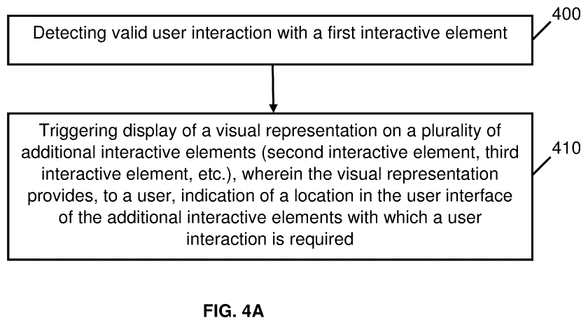

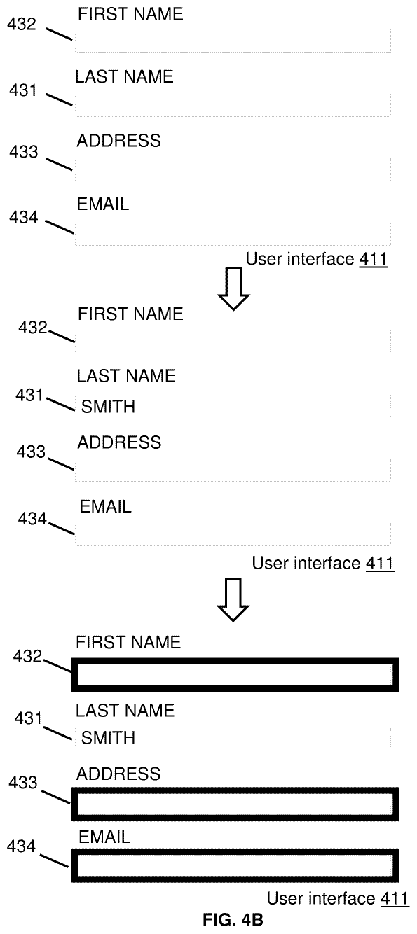

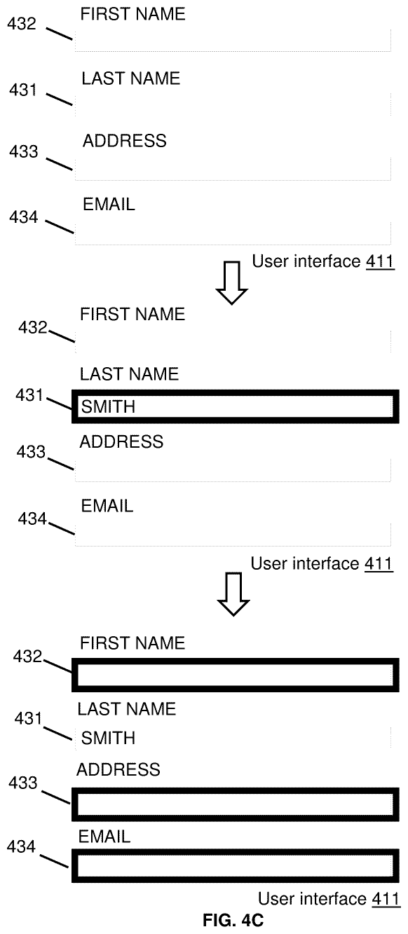

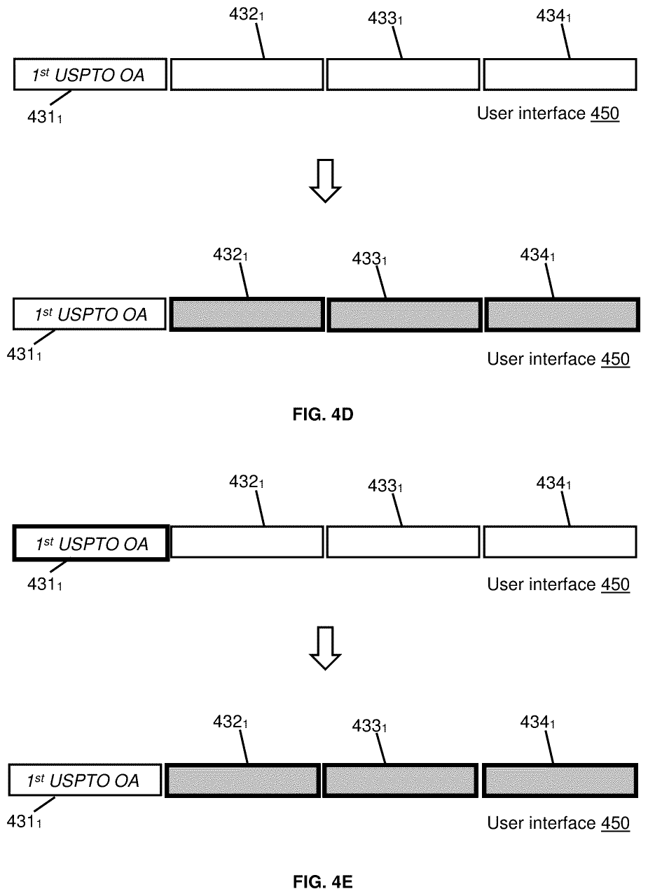

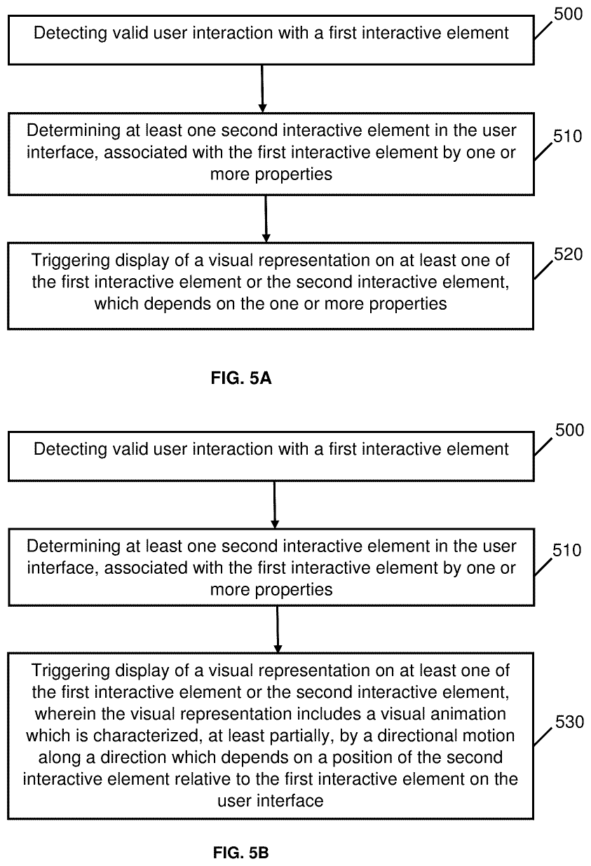

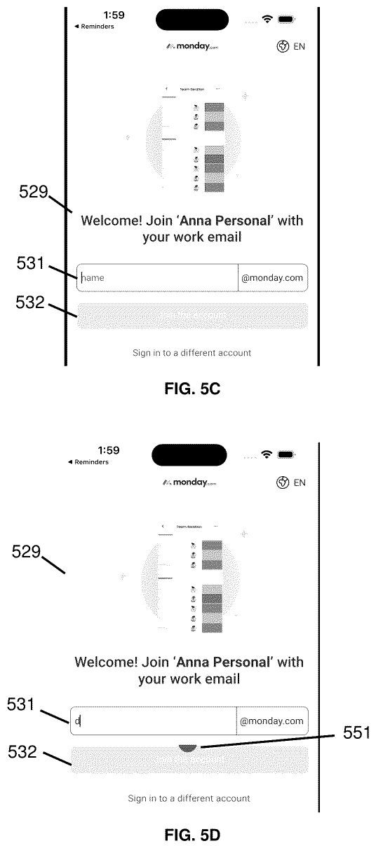

In some examples, before display of the visual representation (operation 210), the second interactive element is already in an active state, which enables user interaction therewith. For example, in the case of a form or a board (as will be further elaborated hereinafter, for example, with respect to FIGS. 3A to 3C, 4B to 4E) the second interactive element is an input window, which may be available for text input before display of the visual representation, in a similar manner to the first interactive element.

In other examples, before display of the visual representation (operation 210), the second interactive element is in an inactive state. In response to detection of a valid user interaction with the first interactive element, the visual representation is displayed, and the second interactive element is switched from its inactive state to its active state.

In some examples, before display of the visual representation (operation 210), the second interactive element is in an inactive state, in which it is associated with a first set of graphical properties defining display of the second interactive element in the user interface. In response to detection of a valid user interaction with the first interactive element, the visual representation is displayed, and the second interactive element is switched from its inactive state to its active state, in which it is associated with a second set of graphical properties, different from the first set of graphical properties.

Note that the method of FIG. 2A can be repeated throughout the various interactions of the user with the user interface. For example, when the user performs a valid user interaction with the second interactive element, the method can include triggering display of another visual representation on the second interactive element and/or on a third interactive element, which provides, to the user, indication of a location in the user interface of the third interactive element with which a user interaction is required. This method can be repeated throughout the user interface with different interactive elements each time, until a completion criterion is met. For example, the completion criterion is met when the form has been fully completed by the user, or when a specific user interaction has been performed (e.g., click on a validation button). In the example of FIGS. 4B and 4C (discussed hereinafter), the completion criterion can be met when the user has entered a valid text in all of the interactive elements 431 to 434.

FIG. 2C illustrates a more detailed example of implementing operation 200, in which a valid user interaction with an interactive element of the user interface can be detected. Note that the method of FIG. 2C is not limitative. FIG. 2D illustrates various examples of data which can be generated and/or processed in the method of FIG. 2C.

In some examples, the method of FIG. 2C can be performed e.g., by PMC 104. In other words, the method of FIG. 2C can be performed locally by the first computerized device 100 (see FIG. 1) used by the user to interact with the user interface, without requiring processing by a remote second computerized device 150 (see FIG. 1). The time required for detecting valid user interaction is therefore reduced with respect to a solution in which remote processing is required. As a consequence, display of the visual representation in response to the detection of the valid user interaction is performed within a shorter timeline.

In some examples, the method of FIG. 2C can be performed e.g., by PMC 160. In other words, the method of FIG. 2C can be performed remotely by a remote second computerized device 150 (see FIG. 1).

In some examples, the method of FIG. 2C can be performed both by PMC 104 and PMC 160. Part or all of the operations described with reference to FIG. 2C can be split between PMC 104 and PMC 160.

The method of FIG. 2C includes obtaining (operation 2001) data 250 informative of the interaction performed by the user with the first interactive element. Data 250 can include e.g., data provided by the user using the interface 108 (e.g., text input provided by the user), a signal informative of an action(s) performed by the user using the interface 108 (e.g., a signal informative of a click by the user), etc. Various non-limitative examples are provided hereinafter.

The method of FIG. 2C further includes determining (operation 2002) whether data 250 obtained at operation 2001 meets one or more predefined conditions 251 which define a valid user interaction. In some examples, the one or more predefined conditions 251 can be included within properties defining the first interactive element. For example, the one or more predefined conditions 251 can be stored in the DOM defining the first interactive element. In some examples, the one or more predefined conditions 251 can be included within properties defining the user interface. The predefined condition(s) 251 can be stored in a computer memory, which is accessible by PMC 104 and/or PMC 160. In some examples, the predefined conditions 251 can be stored in a memory of the first computerized device 100 used by the user, such as the memory of PMC 104. In some examples, the memory stores the predefined condition(s) defining a valid user interaction for each interactive element with which a user interaction is expected.

If it is determined at operation 2002 that data 250 informative of the interaction performed by the user with the first interactive element meets the one or more predefined conditions 251, data 252 informative of a valid user interaction can be generated, for example by PMC 104 and/or PMC 160. In some examples, generation (and/or reception) of data 252 by PMC 104 and/or PMC 160 triggers display of a visual representation, in compliance with operation 210 of FIG. 2A.

If it is determined at operation 200₂ that data 250 informative of the interaction performed by the user with the first interactive element does not meet the one or more predefined conditions 251, data 253 informative of an invalid user interaction can be generated, for example by PMC 104 and/or PMC 160. In other examples, if it is determined at operation 200₂ that data 250 informative of the interaction performed by the user with the first interactive element does not meet the one or more predefined conditions 251, neither data 252, nor data 253, are generated. In some examples, since the display of the visual representation is triggered only in response to the generation (and/or reception) of data 252 indicative of a valid user interaction with the first interactive element, the visual representation is not displayed.

Assume, for example, that the first interactive element is an input window enabling text input by the user. The method of FIG. 2C includes obtaining (operation 2001) the text entered by the user (the text is an example of data 250 in FIG. 2D) and determining whether this text meets the one or more predefined conditions 251 associated with the first interactive element (operation 200₂). If it is detected that this text meets the one or more predefined conditions 251, data 252 indicative of a valid user interaction with the first interactive element can be generated. As mentioned above, data 252 is used to trigger display of a visual representation on at least one of the first interactive element or the second interactive element, in compliance with operation 210 of FIG. 2A.

In some examples, detection of whether the user interaction corresponds to a valid user interaction can be assessed only after the user has finished interacting with the interactive element. For example, when the interactive element includes an input window enabling text input, it can be assessed whether the text entered by the user meets the one or more predefined conditions 251 only once the user has finished typing the text within the input window. Note that detecting that the user has finished typing the text can include (for example) detecting that a sufficient amount of time has elapsed from the last character entered by the user in the input window. In other examples, detection of whether the user interaction corresponds to a valid user interaction can be assessed during the interaction, or immediately. For example, in the case of an interactive element enabling text input, as soon as the user has entered a first character, it is assessed whether this first character meets the one or more predefined conditions, even if the user still enters additional characters. Note that if a valid user interaction has not yet been detected, each time a new character is entered, it is possible to assess again whether the text including the new character meets the one or more predefined conditions.

In some examples, a predefined condition can define that the number of characters entered by the user must be greater than a certain value.

In another example, a predefined condition can define that valid user interaction pertains to a certain type of characters, e.g., only numerals, or a required combination of two or more type of characters, or a certain language, and/or that valid user interaction pertains to a certain text format, e.g., email address, or format of a date, or format of an address, or phone number, etc.

Detecting that the text input of the user meets the one or more predefined conditions (at operation 200₂) can rely on methods such as comparison of the text input with a database, natural language processing (NLP) algorithm(s), trained machine learning model(s), etc. In other examples, detecting that the text input by the user meets the one or more predefined conditions can include comparing the text input with one or more predefined conditions stored in the definition of the interactive element itself (such as in the DOM of the interactive element). For example, a function can be embedded in the DOM of the interactive element, which is configured to compare the text input with one or more predefinition conditions, and, upon detection of a match, generate data 252 informative of a valid user interaction.

In another example, assume that the first interactive element is a clickable element. The method of FIG. 2C includes obtaining (operation 2001) data informative of a click performed by the user on the user interface, and comparing the location of the click on the user interface with the location of the first interactive element (operation 200₂). If there is a match between these two locations, this indicates that a valid user interaction has been performed by the user. Data 252 informative of a valid user interaction can be therefore generated.

Attention is now drawn to FIG. 3A, which depicts a non-limitative example of a user interface 330 presented on a display of a user, including a plurality of interactive elements. The user interface 330 can be used to enter textual data informative of properties of an Office Action. The plurality of interactive elements includes a first input window 331 enabling text input (name of the Office Action) and a second input window 332 enabling text input (timeline of the Office Action). Note that the user interface 330 includes additional interactive elements: third interactive element 333 (entitled “Label”), fourth interactive element 334 (entitled “Status”), fifth interactive element 335 (entitled “Action”) and sixth interactive element 336 (entitled “Date”). The third, fourth and fifth interactive elements 333, 334, and 335 correspond to a scrolling menu, in which there are predetermined options for a user to choose from. The sixth interactive element 336 enables a user to enter a date according to a predefined template. The sixth interactive element 336 can be associated with a function (e.g., a script) which defines the template (format) according to which the date should be entered by the user.

In the example of FIG. 3A, before display of a visual representation in compliance with operation 210 of FIG. 2A, the first interactive element 331 and the second interactive element 332 of the user interface 330 are both already visible to the user. Note that the fact that the first interactive element 331 and the second interactive element 332 are simultaneously displayed to the user does not prevent the user interface 330 from including additional interactive elements which are not yet part of the displayed portion of the user interface 330, and require an action of a user on the display (such as scroll down and/or zoom-out) to become visible.

In other words, before display of the visual representation, the second interactive element 332 is not an off-screen element (which would require an action to be visible, such as a scroll down), but is rather already displayed to the user together with the first interactive element 331.

According to some examples, the user interaction with the first interactive element 331 can be automatically determined as a valid user interaction in response to the user textual input within the first interactive element 332, without requiring the user to perform additional action(s) apart from entering the text.

In particular, immediately after detecting that the user has entered a text meeting a predefined condition within the first interactive element 331, data 252 informative of a valid user interaction can be generated (as shown in FIG. 2D), which will lead to an automatic trigger of a display of a visual representation on the first interactive element 331 and/or on the second interactive element 332.

The lack of any accompanying action by the user is convenient, since the feedback (visual representation) provided in the user interface enables the user to know immediately whether the input he provided is sufficient to proceed to another interactive element.

FIG. 3B illustrates the user interface 330 of FIG. 3A, in which a user has entered, in the first interactive element 331, the character “A”. In compliance with the methods of FIGS. 2C and 2D, the character “A” is compared to the one or more predefined conditions 331. Assume that, in this example, the one or more predefined conditions 331 define that as soon as a first character has been entered, a valid user interaction needs to be detected. The comparison of the character “A” with the one or more predefined conditions 331 indicates a match. As a consequence, data 252 informative of a valid user interaction can be generated (as illustrated in FIG. 2D).

As explained with reference to operation 210 of FIG. 2A, data 252 informative of a valid user interaction can be used to automatically trigger display of a visual representation. Once the user has entered a valid text input within the first interactive element 331, corresponding in this example to the name of the Office Action, the attention of the user should be drawn to the next interactive element with which a user interaction is required, which corresponds to the second interactive element 332, in which the timeline of the Office Action can be entered. In this non-limitative example, the visual representation 335 modifies the contour of the second interactive element 332 into a contour which is thicker, and which has a different color. Note that this modification of the contour is not limitative.

As a consequence, the attention of the user is immediately drawn to the location of the second interactive element 332, and the user knows that he needs, in his next action, to interact with this second interactive element 332.

FIG. 3C illustrates a variant of the example of FIG. 3B, in the context of the user interface 330.

In FIG. 3C, once it has been detected that the user has entered a valid text input in the first interactive element 331, a display of a visual representation is triggered, both on the first interactive element 331 (see visual representation 339), and on the second interactive element 332 (see visual representation 335).

In this example, the same type of visual representation is used for both the first interactive element 331 and the second interactive element 332: the contour of the first interactive element 331 is modified to a contour which is thicker, and which has a different color, and the same modification is applied to the contour of the second interactive element 332.

This indicates to the user that, after his valid interaction with the first interactive element 331, he is now expected to interact with the second interactive element 332.

Attention is now drawn to FIG. 4A, which is a high-level flowchart of a method according to examples of the presently disclosed subject matter. The method of FIG. 4A can be used on a user interface including a plurality of interactive elements. The plurality of interactive elements includes at least a first interactive element, a second interactive element, and a third interactive element.

Following detection of valid user interaction with the first interactive element (operation 400), the method can include displaying (operation 410) a visual representation on a plurality of additional interactive elements of the user interface (e.g., second interactive element, third interactive element, etc., which are different from the first interactive element), in order to indicate to the user the location of these additional interactive elements (and with which a user interaction is required).

In some examples, a computer memory (such as the memory of PMC 104 and/or PMC 130 and/or a cache memory) stores data (e.g., in the form of a list) about additional interactive elements associated with the first interactive element. The data defines, for the first interactive element, the next interactive element(s) with which a user interaction is required, following a valid user interaction with the first interactive element. When a valid user interaction with the first interactive element is detected, this computer memory is accessed to extract data on additional interactive elements associated with the first interactive element, which are used to trigger a display of a visual representation on these additional interactive elements.

Note that each given interactive element of the user interface can be associated with data, which defines, for this given interactive element, the next interactive elements with which a user interaction is required following a valid user interaction with the given interactive element. This data can be stored as one of the properties defining the given interactive element, such as in the DOM of the given interactive element.

An example of the method of FIG. 4A is illustrated in FIG. 4B, which illustrates a user interface 411 including a first interactive element 431, a second interactive element 432, a third interactive element 433, and a fourth interactive element 434. Each interactive element 431 to 434 enables text input by the user. According to a particular example (illustrated in FIG. 4B), the first interactive element 431 enables entering the last name of a person, the second interactive element 432 enables entering the first name of the person, the third interactive element 433 enables entering the address of the person, and the fourth interactive element 434 enables entering the email of the person.

A user enters in the first interactive element 431 the text “SMITH”. In compliance with some examples of the method of FIGS. 2C and 2D, as soon as the user enters the first character “S” of the name “SMITH”, this first character “S” is compared to the one or more predefined conditions 331. Assume that, in this example, the one or more predefined conditions 331 define that as soon as a first character has been entered, a valid user interaction is detected. The comparison of the character “S” with the one or more predefined conditions 331 therefore indicates a match. As a consequence, data 252, informative of a valid user interaction, is generated, which is used to trigger display of a visual representation.

As mentioned above, in some examples, a computer memory (such as the memory of PMC 104 and/or PMC 160 and/or a cache memory) is configured to store data (e.g., in the form of a list) which associates the first interactive element 431 with additional interactive elements of the user interface 411. In this example, assume that data in the computer memory associates the first interactive element 431 with the second interactive element 432, the third interactive element 433, and the fourth interactive element 434. This data therefore indicates that the next interactive elements with which a user interaction is required following a valid user interaction with the first interactive element 431 corresponds to the second interactive element 432, the third interactive element 433, and the fourth interactive element 434.

In some examples, operation 410 of the method of FIG. 4A includes using the data indicative of the next interactive element(s) (as defined above) and the data 252 informative of a valid user interaction with the first interactive element 431, to trigger display of a second visual representation on the second interactive element 432, a third visual representation on the third interactive element 433, and a fourth visual representation on the fourth interactive element 434. In particular, in this non-limitative example, the contour of each of the second, third, and fourth interactive elements 432, 433 and 434, is modified to be thicker and with a color different from the original color. Note that a different visual representation could be displayed on the second, third, and fourth interactive elements 432, 433 and 434, such as making their contour thicker (without changing the color of the contour), or changing the color of their contour (without changing the thickness of the contour), or using other visual representations which are not depicted in FIG. 4B. In the example of FIG. 4B, the same type of visual representation is used for the second, third, and fourth interactive elements 432 to 434. This is however not limitative, and a different visual representation can be used.

In some examples, the method of FIG. 4A can include, following detection of a valid user interaction with the first interactive element, displaying a visual representation on the first interactive element, and then on the plurality of additional interactive elements, with which a user interaction is required. A non-limitative example of this usage of the method of FIG. 4A is illustrated in FIG. 4C, which illustrates the same user interface 411 as in FIG. 4B.

In the example of FIG. 4C, assume that a user enters in the first interactive element 431 the text “SMITH”. Assume that this text is detected as a valid user interaction, as explained above with reference to FIG. 4B. As a consequence, data 252 informative of a valid user interaction with the first interactive element 431, is generated.

The data 252 is used (e.g., by PMC 104 and/or PMC 160) to trigger display of a first visual representation on the first interactive element 431. In this example, the contour of the first interactive element 431 is modified to be thicker and with a different color. Note that a different visual representation could be displayed on the first interactive element 431, such as making its contour thicker (without changing the color of the contour) or changing the color of its contour (without changing the thickness of the contour), or using other visual representations which are not depicted in FIG. 4C.

Then, the first visual representation is removed from the first interactive element 431 (which is brought back to its original graphic representation). As mentioned above, data stored in a computer memory can indicate the next interactive elements with which a user interaction is required following a valid user interaction with the first interactive element 431. In the example of FIG. 4C, the data indicates that the next interactive elements with which a user interaction is required following a valid user interaction with the first interactive element 431, correspond to the second, third, and fourth interactive elements 432, 433, and 434. In the example of FIG. 4C, this data is therefore used to trigger display of a visual representation on each of the second, third, and fourth interactive elements 432, 433 and 434. In particular, a contour of each of the second, third, and fourth interactive elements 432, 433, and 434 is modified to be thicker and with a color different from the original color. Note that a different visual representation could be displayed on the second, third, and fourth interactive elements 432, 433 and 434, such as making their contour thicker (without changing the color of the contour), or changing the color of their contour (without changing the thickness of the contour), or using other visual representations which are not depicted in FIG. 4C.

FIG. 4D illustrates another example of a user interface 450 in which the method of FIG. 4A can be used. In this example, the user interface 450 of FIG. 4D includes four interactive elements (first interactive element 4311, second interactive element 4321, third interactive element 4331, and fourth interactive element 4341), all located on the same horizontal axis of the user interface 450. Note that the user interface 450 can include additional interactive elements, which are not visible in FIG. 4D. The first interactive element 4311 enables a user to define a name of an item, and the second, third, and fourth interactive elements 4321, 4331, and 4341 enable the user to enter textual data defining properties of the item defined in the first interactive element 4311. Upon providing a (valid) name in the first interactive element 4311, the method of FIG. 4A can be utilized to encourage the user to provide additional data in the user interface (i.e., in the second, third, and fourth interactive elements 4321, 4331, and 4341).

Assume, for the sake of example, that the user has entered, in the first interactive element 4311, the text “1^{st} USPTO) (A” (1^{st} Office Action issued by the USPTO).

In compliance with some examples of the method of FIGS. 2C and 2D, as soon as the user enters the first character “1” of the text “1^{st} USPTO) O)A”, this first character “1” is compared to the one or more predefined conditions 331. Assume that, in this example, the one or more predefined conditions 331 define that as soon as a first character has been entered, a valid user interaction is detected. The comparison of the character “1” with the one or more predefined conditions 331 therefore indicates a match. As a consequence, data 252, informative of a valid user interaction, is generated, which is used to trigger display of a visual representation.

As mentioned above, in some examples, a computer memory (such as the memory of PMC 104 and/or PMC 160 and/or a cache memory) is configured to store data (e.g., in the form of a list) which can indicate the next interactive elements with which a user interaction is required following a valid user interaction with the first interactive element 4311. In the example of FIG. 4D, the data indicates that the next interactive elements with which a user interaction is required, following a valid user interaction with the first interactive element 4311 corresponding to the second, third, and fourth interactive elements 4321, 4331 and 4341.

In some examples, the method of FIG. 4A includes using the data indicative of the next interactive element(s) and the data 252 informative of a valid user interaction with the first interactive element 4311, to trigger display of a second visual representation on the second interactive element 4321, a third visual representation on the third interactive element 4331, and a fourth visual representation on the fourth interactive element 4341. In particular, in this non-limitative example, the contour of each of the second, third, and fourth interactive elements 4321, 4331 and 4341 is modified to be thicker (or to thicken gradually). In the present example, the contour of each of the second, third, and fourth interactive elements 4321, 4331 and 4341 is modified to have a color which is different from the original color. Alternatively, or additionally, the color of the interior of each of the second, third, and fourth interactive elements 4321, 4331 and 4341 can be also modified (this modification is also illustrated in FIG. 4A). The attention of the user is therefore immediately drawn to the additional interactive elements with which a user interaction is required.

In the example of FIG. 4D, the same type of visual representation is used for the second, third, and fourth interactive elements 4321, 4331 and 4341. This is however not limitative, and a different visual representation can be used for these interactive elements.

FIG. 4E illustrates the same user interface 450 as in FIG. 4D, on which the method of FIG. 4A can be used. FIG. 4E illustrates another example of a sequence of visual representations that can be displayed.

Assume, for the sake of example, that the user enters, in the first interactive element 4311, the text “1^{st} USPTO) O)A” (1^{st} Office Action issued by the USPTO). As explained above with reference to FIG. 4D, this text is considered as a valid user interaction, and data 252 informative of a valid user interaction is generated.

In the example of FIG. 4E, data 252 informative of a valid user interaction is used to trigger display of a first visual representation 450 on the first interactive element 4311. In this example, the contour of the first interactive element 4311 is modified to be thicker (or to thicken gradually). In some examples, the contour of the first interactive element 4311 can be modified to have a different color. Note that different visual representations can be used.

Optionally, the first visual representation 450 is removed, and a display of a second visual representation on the second interactive element 4321, a third visual representation on the third interactive element 4331, and a fourth visual representation on the fourth interactive element 4341, is triggered. In the illustrated example, the second, third, and fourth visual representations are the same as the one described with reference to FIG. 4D. This is not limitative and different visual representations can be displayed. The attention of the user is therefore immediately drawn to the additional interactive elements with which a user interaction is required.

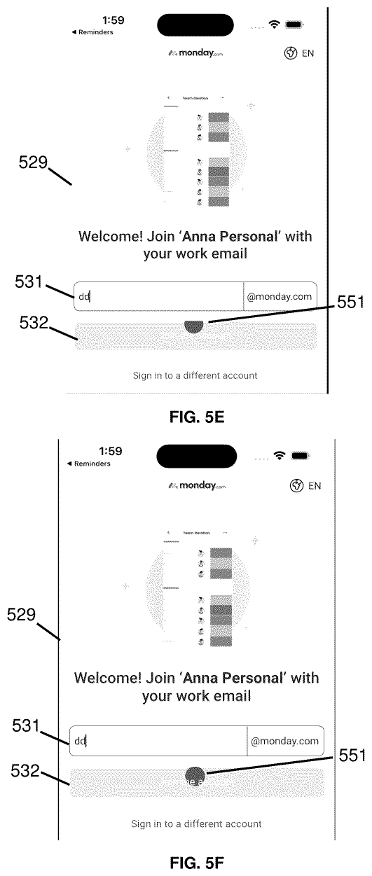

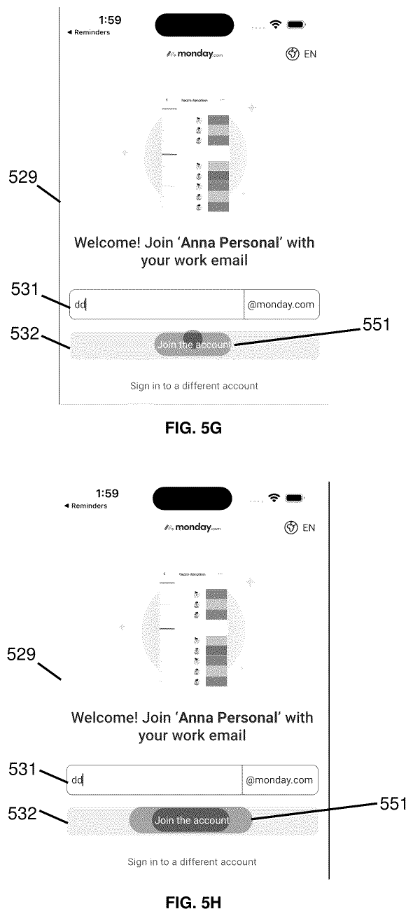

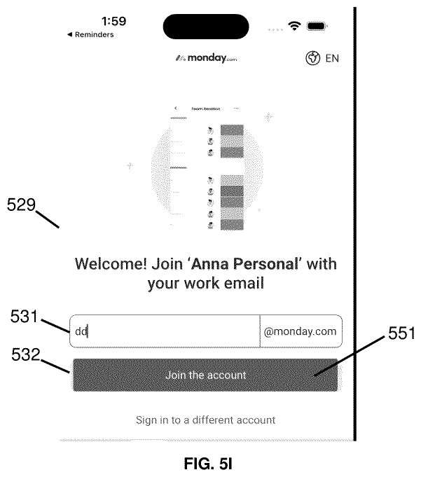

Attention is now drawn to FIG. 5A, which is a high-level flowchart of a method of providing interactive feedback, according to examples of the presently disclosed subject matter. In particular, the method of FIG. 5A provides interactive feedback in a user interface, which depends on one or more properties linking interactive elements of the user interface. This interactive feedback can be viewed as “context induced” feedback, meaning that it provides an indication which depends on some type of contextual relation linking different interactive elements of the user interface. This type of interactive feedback facilitates the interaction of the user with the user interface. In particular, the user can better understand which user interaction is expected. The user can also better understand the link(s) between the various interactive elements of the user interface. Lastly, display of context induced feedback is beneficial to draw the attention of the user to the location(s) of the next interactive element(s) with which a user interaction is expected. The method of FIG. 5A can be used with a user interface including a plurality of interactive elements, which includes at least a first interactive element and a second interactive element.

The method of FIG. 5A includes detecting (operation 500) valid user interaction with a first interactive element of the user interface. Operation 500 is similar to operation 200 and is not described again. As explained above with reference to FIGS. 2C and 2D, detection of valid user interaction with the first interactive element triggers generation of data 252 informative of a valid user interaction.

In response to the generation of data 252 informative of a valid user interaction, the method of FIG. 5A further includes determining (operation 510) at least one second interactive element in the user interface, associated with the first interactive element by one or more properties. Note that determination of the second interactive element can be performed by the selection logic 180 based on the one or more properties linking the second interactive element to the first interactive element, as explained hereinafter with reference to FIG. 11. Various non-limitative examples of properties have already been provided above, and are also provided hereinafter with reference to FIG. 11.

The method of FIG. 5A further includes triggering (operation 520) display of a visual representation which depends on the one or more properties linking the first interactive element to the second interactive element. In particular, one or more graphical properties of the visual representation can be selected to reflect the one or more properties, thereby providing context-induced feedback to the user. In some examples, the visual representation can include a visual animation, wherein one or more graphical properties of the visual animation are selected to reflect the one or more properties. This will be further detailed hereinafter with respect to FIG. 5B. As already explained with reference to FIG. 2A, the visual representation can be displayed on at least one of the first interactive element or the second interactive element.

Attention is now drawn to FIG. 5B, which is an example of a method of providing interactive feedback in a user interface including a plurality of interactive elements, in accordance with the method of FIG. 5A. In particular, the method of FIG. 5B enables generation of a visual representation which depends on a position of a second interactive element of the user interface with respect to a position of a first interactive element of the user interface (this relative position is an example of a property linking the second interactive element to the first interactive element).

The method of FIG. 5B includes operations 500 and 510, already described in connection with FIG. 5A. As explained above, following operation 510, a second interactive element of the user interface is determined, which is linked to the first interactive element by one or more properties.

Assume that a property linking the second interactive element to the first interactive element corresponds to a position of the second interactive element relative to the position of the first interactive element in the user interface. For example, the second interactive element can be an interactive element which is located immediately below the first interactive element, or on the same horizontal axis as the first interactive element, or at some other position. The method of FIG. 5B includes triggering (operation 530—which is an example of operation 520) display of a visual representation which depends on this property linking the second interactive element to the first interactive element. In some examples, the visual representation can include a visual animation which is characterized, at least partially, by a directional motion along a direction which depends on a position of the second interactive element relative to the first interactive element on the user interface.

In other words, during at least a fraction of the total duration of the visual animation, this visual animation has a directional motion along a direction which is indicative of a position of the second interactive element relative to the first interactive element in the user interface.

By virtue of the directional motion of the visual animation, the attention of the user is drawn to the second interactive element with which a user interaction is required (following the valid user interaction with the first interactive element), thus assisting the user in correctly completing the form (e.g., according to a prescribed order, or according to prescribed condition(s) and result(s)). In some examples, in case each valid user interaction triggers display of a visual representation on the next interactive element(s), and/or triggers a switch of the next interactive element(s) from an inactive state to an active state, the user is rewarded with the feeling that his interactions cause the process of completing the form to advance.

In some examples, the position of the second interactive element in the user interface (e.g., form or document), relative to the first interactive element is predefined, and does not change. In this case, the properties of the visual representation which is displayed in response to valid interaction with the first interactive element, can be stored in a computer memory. Specifically, the property of the directional motion, which depends on the position of the second interactive element relative to the first interactive element, can be predefined. PMC 104 and/or PMC 160 can be configured to access this computer memory and trigger display of the visual representation at operation 530.

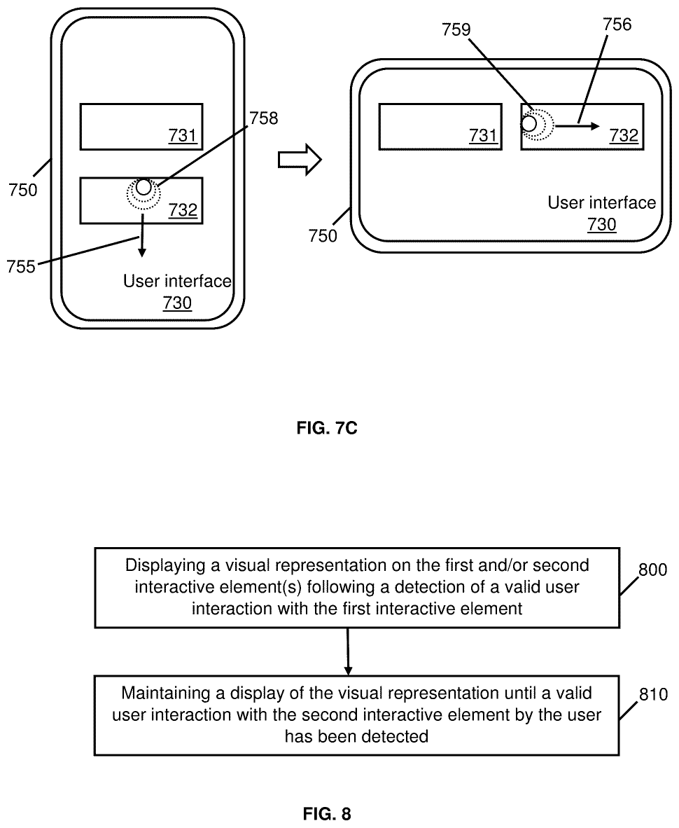

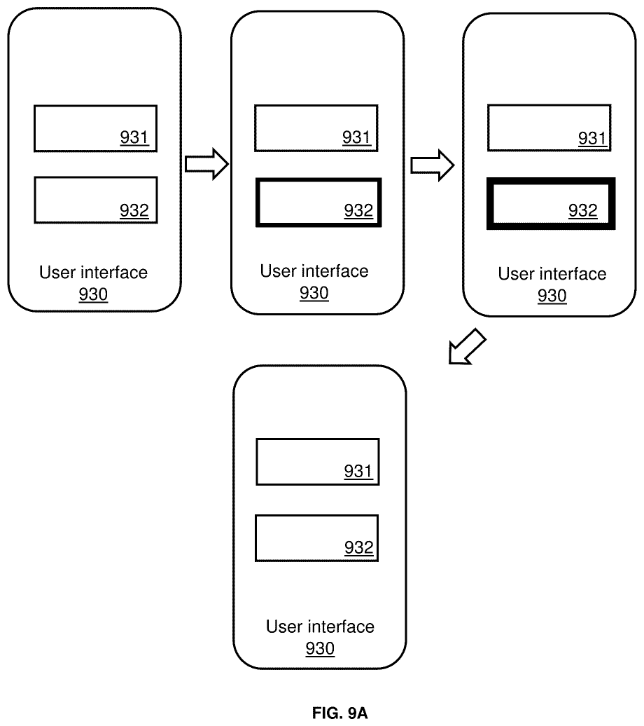

In other examples, the position of the second interactive element, relative to the first interactive element, may change. In some examples, interactions of the user with the interactive elements may induce a change in one or more properties of the interactive elements, such as their position. In some examples, a position of the second interactive element, relative to the first interactive element, may change, depending on the size and/or the orientation of the display 110 presenting the user interface. This will be further discussed hereinafter with reference to FIGS. 7A to 7C.

In some examples, display of the visual animation (with a directional motion) at operation 530 can be triggered while the user is still interacting within the first interactive element (for example, while the user is still entering text within the first interactive element, as depicted in FIGS. 5D and 5E).

In some examples, assume that after triggering of the display of a first visual animation (in response to a first user input within the first interactive element, detected as valid), the first user input is modified (by the user) into a second user input within the first interactive element, detected as invalid. Note that detection of valid or invalid user input may rely for example on the method described with reference to FIGS. 2C and 2D. Assume for example that the first interactive element enables text input, and that the first user input includes a first set of characters detected as valid user input. The user may delete this first set of characters from the first interactive element, and this second user input (empty input in this example) can be detected as invalid user input. Alternatively, the user may modify the first set of characters into a second set of one or more characters (corresponding to a second user input), detected as invalid user input. In some examples, following detection of the second user input as invalid user input, display of a second visual animation can be triggered. In some examples, the second visual animation corresponds to the first visual animation which has been reversed. In some examples, the second visual animation corresponds to the first visual animation which is displayed backwards, until it disappears. In some examples, assume that the first visual animation has, during at least a first period of time, a directional motion along a given axis. The second visual animation can be selected to have, during at least a second period of time, a directional motion along the same given axis (or along an axis parallel to this given axis), but in the opposite direction with respect to the first visual animation. For example, at least part of the first visual animation can move along a given line, in a certain direction e.g., from the first interactive element towards the second interactive element, and the second visual animation can be selected to move along the same given line (or along a line parallel to this given line), with an opposite direction, from the second interactive element towards the first interactive element. In some examples, the second visual animation can draw the attention of the user to the location of the first interactive element. This can facilitate correction by the user of the invalid user input entered in the first interactive element.

A non-limitative example of a usage of the method of FIG. 5B is depicted in FIGS. 5C to 51, which depict a user interface 529 at different instants of time.

In the example depicted in FIGS. 5C to 51, the user interface 529 includes a first interactive element 531 which is an input window enabling text input, and a second interactive element 532 which is a clickable element. The user interface 529 depicted in this example corresponds to an email login webpage.

The first interactive element 531, which is in its active state, requires the user to enter his email address, and the second interactive element 532 is a clickable element enabling pursuing the authentication process, which is initially in an inactive state, as demonstrated by its grey graphic representation.

In this example, once a valid user interaction is detected with the first interactive element 531 (operation 500), it is determined that the next interactive element, with which a user interaction is expected, corresponds to the second interactive element 532 (operation 510). Note that determination of the second interactive element 532 can use the method of FIG. 11. In this particular example, the second interactive element 532 is linked to the first interactive element 531 by at least two properties. There is a required order of interaction between the first interactive element 531 and the second interactive element 532 (first property): the email address should first be entered within the first interactive element 531 and then the user should click on the second interactive element 532 to join his account. In addition, the second interactive element 532 is located below the first interactive element 531 in the user interface 529 (second property).

Once the second interactive element 532 has been identified, display of a visual representation, including an animated element 551, is triggered (operation 530).

As explained above with reference to FIGS. 5A and 5B, in some examples of the present invention, at least part (or all of) the visual animation is indicative of one or more properties linking the interactive elements. As visible in FIGS. 5D and 5E, during part of the duration of the visual animation, the visual animation includes an animated element 551 which is displayed with a motion which has a direction oriented from the first interactive element 531 towards the second interactive element 532. In this non-limitative example, the animated element 551 has a motion along a vertical axis, from top to bottom, since the second interactive element 532 is located below the first interactive element 531. In other words, the animated element 551 has a motion which reflects the second property (position of the second interactive element 532 relative to the first interactive element 531). Note that since the animated element 551 is displayed only after a valid user interaction with the first interactive element 531, it also reflects the first property (required order of interaction between the first interactive element 531 and the second interactive element 532, as defined above).

Note that if the position of the second interactive element 532 with respect to the first interactive element 531 is different, then the direction of the motion of the animated element 551 can be adapted accordingly (this direction can therefore be different from the vertical direction). In some examples, a computer memory (accessible by PMC 104 and/or PMC 160) stores in advance a plurality of different visual animations, wherein each visual animation is associated with a directional motion along a different direction. It is therefore possible to extract, from the computer memory, the visual animation associated with the directional motion which is selected based on the position of the second interactive element with respect to the position of the first interactive element. In other examples, an Artificial Intelligence (AI) algorithm (which includes e.g., a machine learning model) can be used to generate a visual animation associated with a directional motion, depending on the position of the second interactive element relative to the position of the first interactive element. The Artificial Intelligence (AI) algorithm can be implemented by a processor and memory circuitry, such as (but not limited to) PMC 104 and/or PMC 160.

In the illustrated example, animated element 551 is represented as a blob which moves within the second interactive element 532, in the direction oriented from the first interactive element 531 towards the second interactive element 532. The direction along which the blob moves, from the top part of the second interactive element 532 to the middle thereof, thereby generating a downwards motion, reflects the fact that the first interactive element 531 is located above the second interactive element 532. It therefore assists in guiding the attention of the user from the first interactive element 531 to the second interactive element 532. Note that this type of visual representation is only an example, and various other types of visual representations can be used.

In some examples, the visual animation can include a second portion which is not indicative of the one or more properties linking the first interactive element to the second interactive element. As shown in FIGS. 5G to 51, once a position of the animated element 551 (blob) reaches a certain area within the second interactive element 532, the animated element 551 interacts with the graphical representation of the second interactive element 532 by expanding within the graphical representation of the second interactive element 532, and accumulating the shape of the graphical representation of the second interactive element 532. This second portion of the visual animation does not depend on the position of the second interactive element with respect to the position of the first interactive element.

In some examples, detection of a valid user interaction with the first interactive element 531 can trigger switching of the second interactive element 532 from an inactive state to an active state.

In some examples, once the animated part of the visual representation has ended, the visual representation can remain present, as a change in the color of the second interactive element 532. The change in color serves to make the second interactive element 532 (“Join the account”) more noticeable to the user. In other examples, the visual representation does not change the color of the second interactive element 532.

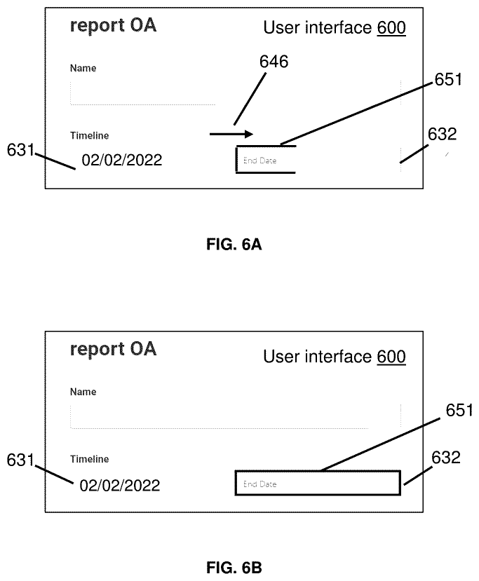

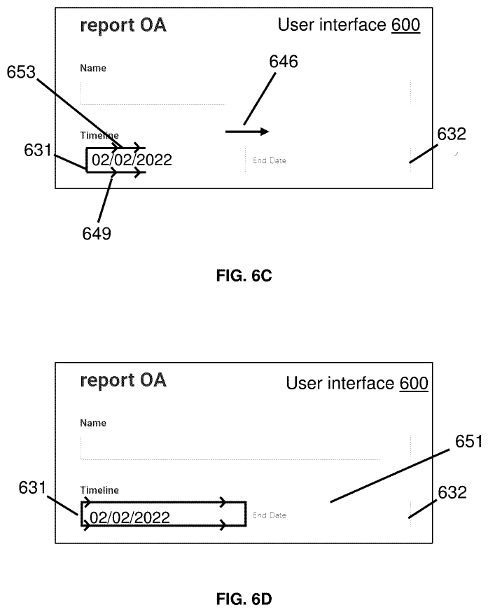

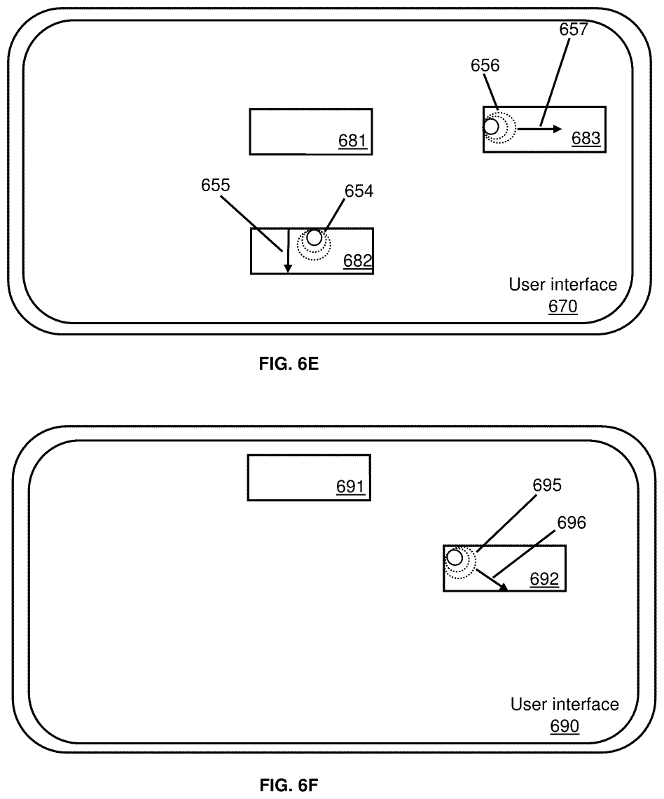

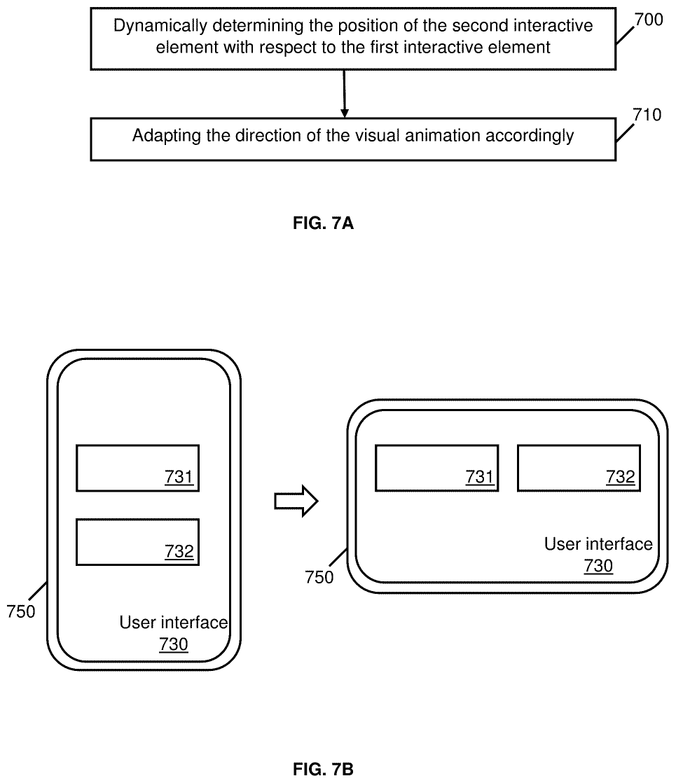

FIG. 6A and FIG. 6B illustrate another example of a visual representation which includes a visual animation characterized, at least partially, by a directional motion along a direction which depends on a position of a second interactive element relative to a first interactive element on a user interface. FIG. 6A illustrates a user interface 600 at a first instant of time, and FIG. 6B illustrates the user interface 600 at a second instant of time, after the first instant of time.

The user interface 600 depicted in FIGS. 6A and 6B includes a first interactive element 631, and a second interactive element 632 which is located on the same horizontal axis as the first interactive element 631, on the right side thereof. These two interactive elements 631, 632 enable text input by the user.

Once a valid user interaction has been detected with the first interactive element 631 (operation 500 in FIGS. 5A and 5B), a visual representation including a visual animation 651 is displayed, which has (during at least part of its duration) a motion along a direction 646, corresponding to the relative position between the first and second interactive elements 631, 632. Specifically, direction 646 is oriented from the first interactive element 631 to the second interactive element 632 (horizontal direction, from left to right). In this example, the visual animation 651 includes progressively modifying the color and/or the thickness of the contour of the second interactive element 632 along the direction 646.

Attention is now drawn to FIGS. 6C and 6D, which depict the same user interface 600 as in FIGS. 6A and 6B. FIG. 6C illustrates a user interface 600 at a first instant of time, and FIG. 6D illustrates the user interface 600 at a second instant of time, after the first instant of time. FIG. 6C and FIG. 6D illustrate another example of a visual representation which includes a visual animation, characterized, at least partially, by a directional motion along a direction which depends on a position of the second interactive element 632 relative to the first interactive element 631 on the user interface 600.

In the example of FIGS. 6C and 6D, once a valid user interaction has been detected with the first interactive element 631 (operation 500 in FIGS. 5A and 5B), a visual representation including a visual animation 653 is displayed on the first interactive element 631, which has (during at least part of its duration) a motion along a direction 646, corresponding to the relative position between the first and second interactive elements 631, 632. Specifically, direction 646 is oriented from the first interactive element 631 to the second interactive element 632 (horizontal direction, from left to right). In this example, the visual animation 653 includes progressively modifying the color and/or the thickness of the contour of the first interactive element 631 along the direction 646. In addition, arrows 649 which indicate the direction 646 can be displayed on the contour of the first interactive element 631.

There have been described, with reference to FIGS. 5B to 51, examples of a visual animation which has a directional motion which depends on a position of the second interactive element relative to the first interactive element (corresponding to a property linking the second interactive element to the first interactive element).

In other examples, assume that a property linking the first interactive element to the second interactive element corresponds to a similarity in a graphical property, such as the same color, or the same shape, or any other graphical property. In accordance with the method of FIG. 5A, it is possible to select a visual representation (which may, or may not, include a visual animation) which has at least one graphical property which reflects this common property. For example, assume that both the contour of the first interactive element and the contour of the second interactive element have a red color. Following a valid user interaction with the first interactive element, a visual representation with a red color can be displayed in order to draw the attention of the user to the fact that these two interactive elements are linked.

In other examples, assume that a property linking the first interactive element to the second interactive element corresponds to a required order of interaction. In particular, assume that the user needs to first interact with the first interactive element, and only then with the second interactive element. In accordance with the method of FIG. 5A, it is possible to select a visual representation (which may include a visual animation) which reflects this common property (required order of interaction). In some examples, a visual representation is displayed on the second interactive element only after detection of a valid user interaction with the first interactive element. In other examples, once a valid user interaction with the first interactive element has been detected, a first visual representation may be first displayed on the first interactive element, and then, this first visual representation is removed, and a second visual representation may be displayed on the second interactive element (note that FIGS. 4C and 4E illustrate non-limitative examples of such a sequence). This order in the display of the first and second visual representations helps the user to understand the required order of interaction within the interactive elements of the user interface.

In some examples, the visual representation displayed on the user interface, following valid user interaction with a first interactive element, can include at least two different visual animations. For example, the examples of FIGS. 6A to 6D can be combined, where the first visual animation 653 on the first interactive element 631, and the second visual animation 651 on the second interactive element 632, are both displayed (simultaneously, in overlapping timeframes, or one after the other).

In some examples in which a plurality of visual animations is used, at least two visual animations thereof can be configured to move along a different direction. This can be useful when it is intended to provide indication to the user on the location of a plurality of different interactive elements.

A non-limitative example of a method using a plurality of visual animations is illustrated in the user interface 670 of FIG. 6E, which includes a first interactive element 681, a second interactive element 682 located below the first interactive element 681, and a third interactive element 683 located on the same horizontal axis as the first interactive element 681.

Once a valid user interaction has been detected with the first interactive element 681, display of a first visual animation 654 which moves along a vertical direction 655 (from top to bottom) to indicate a location of the second interactive element 682, and of a second visual animation 656 which moves along a horizontal direction 657 (from left to right) to indicate a location of the third interactive element 683, is triggered.

Note that in some examples the direction joining the first interactive element to the second interactive element can be different from the horizontal axis and the vertical axis, and, if necessary, the direction of the visual animation can be selected to match this direction. This is illustrated in the user interface 690 of FIG. 6F, which includes a first interactive element 691 and a second interactive element 692, located along a diagonal axis 696 with respect to the first interactive element 691. Therefore, the method of FIG. 5A or 5B can include triggering display of a visual animation 695 on the second interactive element 692, which moves along the diagonal axis 696. Note that the visual animation 695 could have been displayed on the first interactive element 691, or on both the first and second interactive elements 691, 692. As mentioned above, visual animation(s) moving along different direction(s) can be stored in a computer memory, and the visual animation(s) with a motion matching the required direction(s) can be extracted from the computer memory. In other examples, visual animation(s) moving along the required direction(s) can be generated using one or more Artificial Intelligence (AI) algorithm(s).

Attention is now drawn to FIG. 7A, which depicts a particular example of the methods of FIGS. 5A and 5B.

In some cases, the position of the second interactive element relative to the first interactive element changes over time, and/or is unknown in advance. This can be done by adapting the user interface to be displayed on different devices with different sizes of displays, and the manner in which the positioning of the interactive elements is determined in the user interface. The method of FIG. 7A enables determining the position of the second interactive element relative to the first interactive element, and selecting a visual representation which includes a visual animation which is characterized, at least partially, by a directional motion selected according to the position of the second interactive element relative to the first interactive element.

The method of FIG. 7A includes (operation 700) dynamically determining the position of the second interactive element with respect to the first interactive element. This can be performed for example, by using a computerized analysis of the source code of the user interface. For example, if the user interface is displayed on a webpage, the source code of the webpage can be analyzed to determine the position of the second interactive element with respect to the first interactive element. In particular, the current position of the first interactive element and the current position of the second interactive element in the user interface can be extracted from the DOM of the user interface.

The method further includes adapting (operation 710) the direction of the visual animation, depending on the position of the second interactive element with respect to the first interactive element (as determined at operation 700).

A computer memory (such as a memory of PMC 104 and/or PMC 160) can be configured to store the properties of different visual animations, wherein each visual animation is associated with a directional motion along a different direction. At operation 710, PMC 104 and/or PMC 160 can extract, from the computer memory, the properties of a visual animation which is characterized by appropriate movement along a direction that matches the direction, going from the position of the first interactive element to the position of the second interactive element, and can trigger the display of the extracted visual animation. In other examples, visual animation(s) moving along the required direction(s) can be generated using one or more Artificial Intelligence (AI) algorithm(s).

The method of FIG. 7A can be applied in different cases. In some examples, the position of the second interactive element relative to the first interactive element is not known in advance. This can be due to the fact that the architecture of the user interface is not known in advance and needs to be “learned” by the system. The method of FIG. 7A is therefore required to dynamically determine the position of the second interactive element with respect to the first interactive element, and to adapt (operation 710) the direction of the visual animation accordingly.

In other examples, an event triggers a change of the position of the second interactive element with respect to the first interactive element. For example, the architecture of the user interface may depend on the orientation of the screen of the first computerized device 100 (e.g., smartphone) of the user, and may change following a change in the screen orientation, and/or following interaction(s) of the user (for example, a user has performed an interaction which requires displaying more or different information in the user interface). In a non-limitative example, the user has selected in a scrolling menu the item “address” instead of the item “postal box”. This user selection triggers display of additional items in the user interface, such as street number, street name, city name, etc.

FIG. 7B illustrates two different orientations of a screen 750 of computerized device (smartphone). The screen 750 displays a user interface 730 including a first interactive element 731 and a second interactive element 732.

When the screen 750 of the smartphone is oriented vertically, the second interactive element 732 is located below the first interactive element 731, and when the screen 730 of the smartphone is oriented horizontally, the first interactive element 731 and the second interactive element 732 are located on the same horizontal axis.

Assume that the visual representation includes an animation which moves (at least during a given period of time) along a direction oriented from the first interactive element 731 towards the second interactive element 732.

The method of FIG. 7A can be used to generate a visual animation with a motion which is selected according to relative position of the first and second interactive elements, which depends on the orientation of the screen (as depicted in FIG. 7C).

When the screen 750 is oriented vertically, a directional animated element 758 (e.g., an animation of a blob moving in a certain direction and, after a predefined period of time, increasing in size) is displayed, which moves along the direction 755 (vertical direction, from top to bottom). This is due to the fact that the second interactive element 732 is displayed below the first interactive element 731, when the screen 750 is oriented vertically.

When the screen 750 is oriented horizontally, a directional animated element 759 (e.g., an animation of a blob moving in a certain direction and, after a predefined period of time, increasing in size) is displayed, which moves along the direction 756 (horizontal direction, from left to right). This is due to the fact that the second interactive element 732 is on the same axis as the first interactive element 731, on its right side, when the screen 750 is oriented horizontally.

Note that the properties of the directional animated element 758 and of the directional animated element 759 can be extracted by PMC 104 and/or PMC 160 from a computer memory storing different visual animations corresponding to different styles of displays.

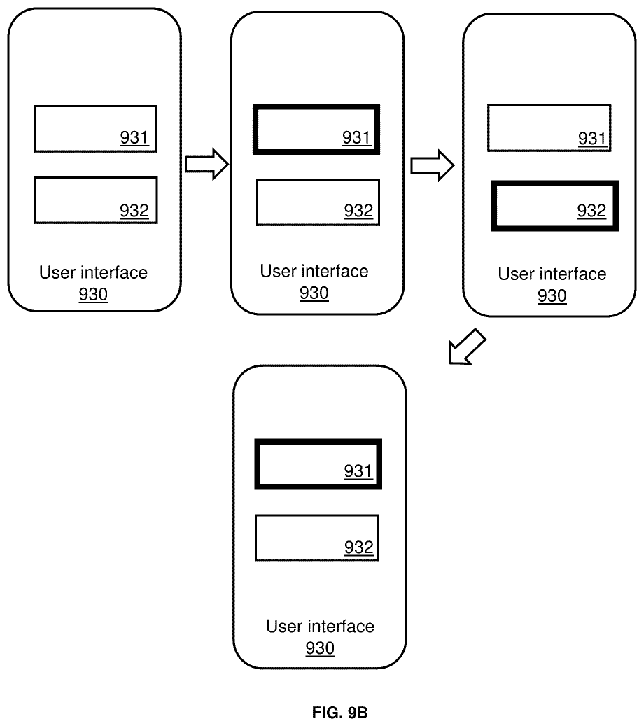

Attention is now drawn to FIG. 8, which is a high-level flowchart of a method according to examples of the presently disclosed subject matter. The method of FIG. 8 enables maintaining display of a visual representation over time, thereby further drawing attention of the user to the next interactive element(s) with which user interaction is required.

As explained in the different examples above, a visual representation is displayed on the first and/or second interactive element(s), following detection of a valid user interaction with the first interactive element (operation 800).

The method of FIG. 8 can include maintaining (operation 810) display of the visual representation until a valid user interaction with the second interactive element by the user has been detected. Once the valid user interaction has been detected, the visual representation can be removed from the user interface.

Indeed, as mentioned above, the visual representation draws the attention of the user towards the second interactive element with which a user interaction is expected. When the user performs a valid user interaction with the second interactive element, this indicates that the visual representation has achieved its goal of drawing the user interaction towards the second interactive element, and this visual representation can therefore be removed from the user interface. The valid user interaction with the second interactive element can correspond, for e.g., to a selection of the second interactive element by the user, to entering valid text input within the second interactive element, etc. Other criteria can be used to assess the valid user interaction with the second interactive element.

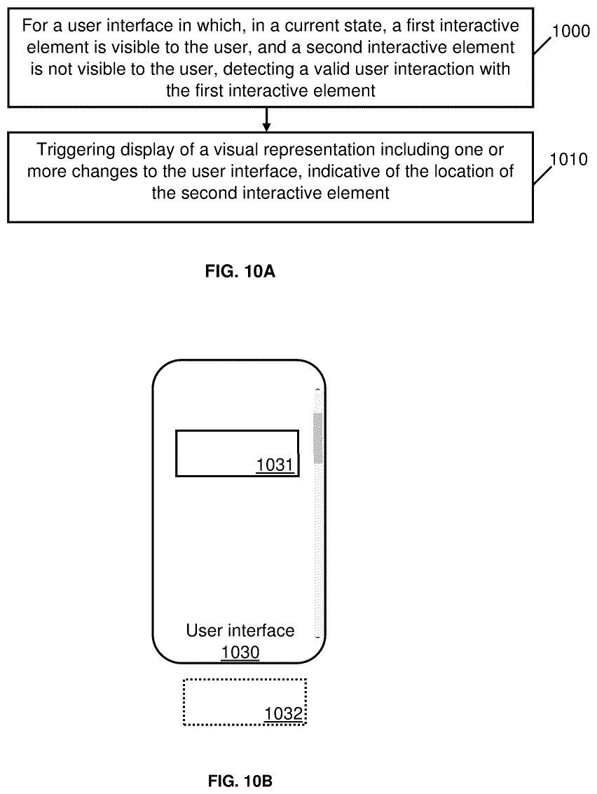

Attention is now drawn to FIGS. 9A and 9B, which depict particular examples of visual representations which can be displayed on a user interface.

In some examples, the visual representation (triggered responsive to a valid user interaction with the first interactive element) can include an animation which is pulsating (also called heartbeat animation, as it mimics the pulses of the heart which alternates between peaks and non-peaks). This type of animation enables efficiently drawing the attention of the user to the location of the second interactive element.

FIG. 9A illustrates a user interface 930 including a first interactive element 931 and a second interactive element 932.

In the example of FIG. 9A, a pulsating animation is displayed. The contour of the second interactive element 932 of the user interface 930 has a thickness which is progressively increased, and then reduced. In some examples, the color of the contour can be also modified, in addition to the thickness of the contour.

Note that this pulsating cycle (which includes increase of the thickness of the contour, followed by a reduction of the thickness) can be repeated a plurality of times.

Although FIG. 9A depicts the pulsating animation only on the second interactive element 932, in some examples it can be displayed also on the first interactive element 931.

FIG. 9B illustrates another example of a pulsating animation. In this example, following detection of a valid user interaction with the first interactive element 931, the following sequence of events can be performed:
the contour of the first interactive element 931 has a thickness which is increased;
the contour of the first interactive element 931 is brought back to its original thickness, and the contour of the second interactive element 932 has a thickness which is increased;
the contour of the second interactive element 932 is brought back to its original thickness.

Note that this sequence can be repeated. This example is not limitative, and other types of pulsating animations can be used (with a different pulsating effect and/or with a different pulse frequency, etc.).

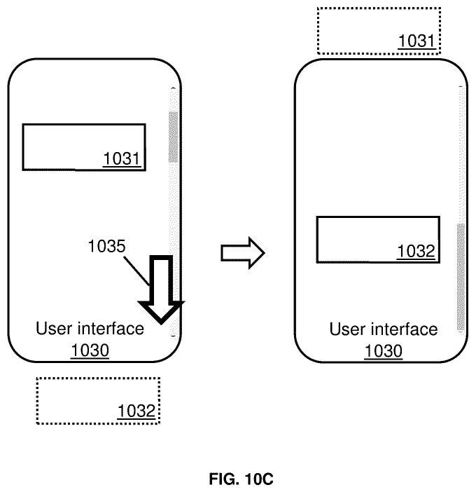

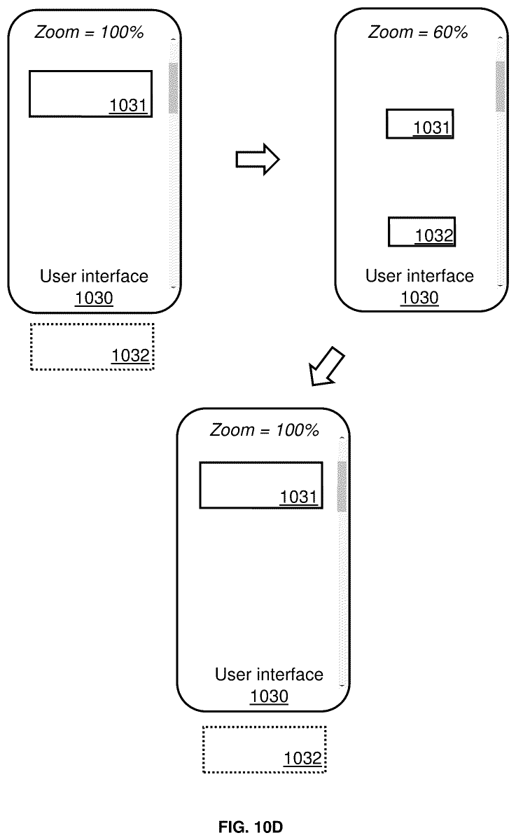

Attention is now drawn to FIG. 10A, which is a high-level flowchart of a method according to examples of the presently disclosed subject matter. The method of FIG. 10A can be applied on a user interface that includes a plurality of interactive elements, which include a first interactive element and a second interactive element.

According to some examples, before display of the visual representation, the first interactive element is visible in the user interface to the user, but the second interactive element is not (currently) visible in the user interface to the user. This can occur, for example, in a user interface which includes a large number of interactive elements, and/or which includes few interactive elements with large dimensions. As a consequence, all interactive elements cannot be displayed simultaneously on the screen.

In other words, before display of the visual representation, the second interactive element is an off-screen element (which requires an action to be visible, such as a scroll down).

An example of this configuration is depicted in FIG. 10B, which depicts a user interface 1030 including a first interactive element 1031 and a second interactive element 1032. In FIG. 10B, the first interactive element 1031 of the user interface 1030 is visible to the user, whereas the second interactive element 1032 is (currently) not visible (not displayed) to the user (off-screen element).

The method of FIG. 10A includes detecting (operation 1000) a valid user interaction with the (currently visible) first interactive element (for example, first interactive element 1031).

In response to this detection, the method includes triggering (operation 1010) display of a visual representation which performs one or more changes to the user interface. These changes provide an indication, to the user, of the location of the second interactive element (for example, second interactive element 1032).

A first non-limitative example of operation 1010 is illustrated in FIG. 10C, which depicts the user interface 1030 of FIG. 10B. Following detection of a valid interaction with the first interactive element 1031, display of an arrow 1035 at the bottom of the user interface 1030 is triggered, which draws the attention of the user to the fact that a scroll down of the user interface 1030 is required to make the second interactive element 1032 visible. The right part of FIG. 10C illustrates the state of the user interface 1030 after the user has performed a scroll down. In some examples, the arrow is clickable, and, when a user clicks on the arrow, this triggers an automatic scroll down of the user interface, in order to display the second interactive element 1032.

A second non-limitative example of operation 1010 is illustrated in FIG. 10D. Following detection of the valid interaction with the first interactive element 1031, a zoom-out of the user interface 1030 (the zoom-out is part of the visual representation) is triggered. This enables displaying, simultaneously, both the first interactive element 1031 and the second interactive element 1032 to the user.

In some examples, following the zoom-out, the method of FIG. 10A can include displaying a visual representation on the second interactive element 1032 in order to draw the attention of the user to the fact that a user interaction is required with the second interactive element 1032, now visible (e.g., by changing graphical properties of the second interactive element 1032).

In some examples, the method of FIG. 10A can further include performing a zoom-in of the user-interface in order to bring back the user interface to its original display, in which the first interactive element is visible to the user, but not the second interactive element.

Attention is now drawn to FIG. 11, which is a high-level flowchart of a method according to examples of the presently disclosed subject matter. The method of FIG. 11 can be applied in a user interface including a plurality of interactive elements.

As explained in the various examples above (see FIGS. 2A, 2C, 4A, 5A, 5B, 7A, 8 and 10A), a valid user interaction is detected with a first interactive element of the user interface (operation 1100).

Once this valid user interaction has been detected, it is intended to trigger display of a visual representation which provides indication of a location of one or more next interactive elements (designated as second interactive element(s)—see FIGS. 2A, 2C, 4A, 5A, 7A, 8 and 10A).

Operation 1105 of FIG. 11 enables determining the second interactive element among the plurality of interactive elements of the user interface. Note that operation 1105 can include determining a single second interactive element, or, alternatively, a plurality of second interactive elements.

In order to determine which interactive element(s) of the user interface correspond to the second interactive element(s), PMC 104 and/or PMC 160 can use the selection logic 180 (already mentioned above in connection with FIG. 1). According to some examples, the selection logic 180 enables PMC 104 and/or PMC 160 to select the second interactive element of the user interface which is associated with the first interactive element by at least one property (or a plurality of properties). Various examples are provided hereinafter.

According to some examples, the selection logic 180 dictates that the second interactive element (with which a user interaction is required after the first interactive element) corresponds to the interactive element which has a position which matches the position of the first interactive element according to a proximity criterion. In this example, the property which links the second interactive element to the first interactive is the proximity in the user interface. For example, the second interactive element is the closest interactive element to the first interactive element. This is not limitative.

According to this example, the method of FIG. 11 therefore includes, at operation 1105, determining the interactive element of the user interface which is the closest to the first interactive element, and selecting this interactive element as the second interactive element.

In some examples, the positions of the interactive elements of the user interface are fixed and known in advance. In this case, a computer memory can store in advance which interactive element is the closest to the first interactive element. PMC 104 and/or PMC 160 can therefore extract the second interactive element from this memory at operation 1105.

In other examples, the positions of the interactive elements of the user interface may change, and/or may be fixed, but unknown in advance. Note that FIG. 7B illustrates an example in which the positions of the interactive elements of the user interface change, depending on the orientation of the screen displaying the user interface. In this case, PMC 104 and/or PMC 160 can dynamically determine the current locations of the different interactive elements of the user interface. For example, PMC 104 and/or PMC 160 can use the DOM of the user interface to determine the positions of the interactive elements of the user interface. Based on this determination, PMC 104 and/or PMC 160 can identify (in accordance with the selection logic 180) the interactive element which is the closest to the first interactive element, and select it as the second interactive element.

According to some examples, the selection logic 180 dictates that the second interactive element (with which a user interaction is required after the first interactive element) corresponds to the interactive element which has a given graphical property which is the same as the first interactive element. In this example, the property which links the second interactive element to the first interactive element, is the similarity in this given graphical property. For example, the second interactive element has the same contour color as the first interactive element, and/or the same shape as the first interactive element. This is not limitative.

According to this example, the method of FIG. 11 therefore includes, at operation 1105, determining the interactive element of the user interface which has the same given graphical property as the first interactive element.

In some examples, the graphical properties of the interactive elements of the user interface are fixed and known in advance. In this case, a computer memory can store in advance which interactive element has the same given graphical property as the first interactive element. PMC 104 and/or PMC 160 can therefore extract the second interactive element from this memory at operation 1105.

In other examples, the graphical properties of the interactive elements of the user interface may change, and/or may be fixed, but unknown in advance. In this case, PMC 104 and/or PMC 160 can dynamically determine the current graphical properties of the different interactive elements of the user interface. For example, PMC 104 and/or PMC 160 can use the DOM of the user interface to determine the current graphical properties of the interactive elements of the user interface. Based on this determination, PMC 104 and/or PMC 160 can identify (in accordance with the selection logic 180) the interactive element which has the same given graphical property as the first interactive element, and select the identified interactive element as the second interactive element.

According to some examples, there is a required order of interaction between interactive elements of the user interface. For example, in an email login webpage, there is a required order of interaction between the interactive elements, in that the user must first enter his email (first interactive element) and only then click “Join the account” (second interactive element), or enter his password (second interactive element). An example is illustrated in FIGS. 5C to 51.

In this example, the selection logic 180 dictates that the second interactive element determined at operation 1105 corresponds to the interactive element with which a user interaction is required as a consequence of an order of interaction required by the user interface. In this example, at least one property linking the second interactive element to the first interactive element includes the required order of interaction between the two elements.

In some examples, the required order of interaction between the interactive elements is fixed and known in advance. In this case, a computer memory can store in advance which interactive element requires a user interaction immediately after a valid user interaction with the first interactive element. PMC 104 and/or PMC 160 can therefore extract the corresponding interactive element from this memory at operation 1105 and select the extracted interactive element as the second interactive element.

In other examples, the required order of interaction may change, and/or may be fixed, but unknown in advance. In this case, PMC 104 and/or PMC 160 can dynamically determine the required order of interaction of the different interactive elements of the user interface. For example, PMC 104 and/or PMC 160 can use the DOM of the user interface to determine the required order of interaction of the interactive elements of the user interface. Based on this determination, PMC 104 and/or PMC 160 can identify (in accordance with the selection logic 180) the interactive element which requires a user interaction immediately after the first interactive element, and select the identified interactive element as the second interactive element.

According to some examples, the selection logic 180 dictates that the second interactive element (with which a user interaction is required after the first interactive element) corresponds to the interactive element which is associated with a content which is the same as the content of the first interactive element. In this example, the property which links the second interactive element to the first interactive is the similarity in the content. For example, assume that the user interface requires a user to complete data regarding different topics (transportation habits, eating habits, etc.). The first interactive element and the second interactive element can pertain to the same topic (transportation habits) within the user interface. This is not limitative.

According to this example, the method of FIG. 11 therefore includes, at operation 1105, determining the interactive element of the user interface which is associated with the same content as the first interactive element, and selecting this interactive element as the second interactive element.

In some examples, the content of each of the interactive elements of the user interface is fixed and known in advance. In this case, a computer memory can store in advance which interactive element has the same content as the first interactive element. PMC 104 and/or PMC 160 can therefore extract the second interactive element from this memory at operation 1105.

In other examples, the content of the interactive elements of the user interface may change, and/or may be fixed, but unknown in advance. In this case, PMC 104 and/or PMC 160 can dynamically determine the current content of the different interactive elements of the user interface. For example, PMC 104 and/or PMC 160 can use the DOM of the user interface to determine the content of the interactive elements of the user interface. Based on this determination, PMC 104 and/or PMC 160 can identify (in accordance with the selection logic 180) the interactive element which has the same content as the first interactive element, and select it as the second interactive element.

In some examples, the selection logic 180 dictates that the second interactive element (with which a user interaction is required after the first interactive element) corresponds to the interactive element of the user which is linked to the first interactive element by at least two (or more) different properties. For example, the second interactive element is associated with the same content as the first interactive element and has the same shape as the first interactive element. This example is not limitative.

Once the second interactive element has been determined at operation 1105, the method of FIG. 11 includes triggering (operation 1110) display of a visual representation on at least one of the first interactive element or the second interactive element. The visual representation provides, to a user, indication of a location in the user interface of the second interactive element with which a user interaction is required.

According to some examples, a type of the visual representation is selected to be indicative of the property linking the second interactive element to the first interactive element.

In other words, a different type of visual representation is selected, depending on the property linking the first interactive element and the second interactive element.

For example, when the first interactive element and the second interactive element pertain to the same content, a pulsating representation can be used (see e.g., FIGS. 9A and 9B).

In another example, when the first interactive element and the second interactive element are linked by their position or their required order of interaction, a visual representation with a directional motion can be used (see e.g., FIGS. 5B to 5I, FIGS. 6A to 6F and 7C). These examples are not limiting.

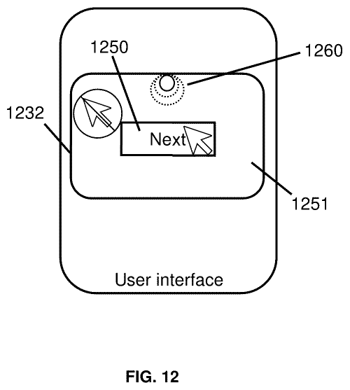

Attention is now drawn to FIG. 12.

According to some examples, the second interactive element 1232 comprises a given area 1250 enabling user interaction and a background area 1251 surrounding this given area. For example, the given 1250 is a clickable area, whereas the background area is not clickable.

In some examples, at least part of the visual representation 1260 is displayed in the background area 1251. This is not limitative.

Embodiments of the presently disclosed subject matter are not described with reference to any particular programming language. It will be appreciated that a variety of programming languages may be used to implement the teachings of the presently disclosed subject matter as described herein.

The invention contemplates a computer program being readable by a computer for executing one or more methods of the invention. The invention further contemplates a machine-readable memory tangibly embodying a program of instructions executable by the machine for executing one or more methods of the invention.

It is to be noted that the various features described in the various embodiments may be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. A computer-implemented method comprising, for a graphical user interface that comprises a plurality of interactive elements comprising a first interactive element and a second interactive element, executing:
responsive to detecting valid user interaction with the first interactive element, performing a modification of the graphical user interface, said performing comprising:
triggering display of a digital visual representation on at least one of the first interactive element or the second interactive element of the graphical user interface, wherein the digital visual representation provides, to a user, indication of a location in the graphical user interface of the second interactive element with which a user interaction is required, thereby providing feedback to the user while interacting with the graphical user interface.

2. The method of claim 1, wherein, before display of the digital visual representation, the first interactive element and the second interactive element are both already visible to the user in the graphical user interface.

3. The method of claim 1, wherein the first interactive element is associated with the second interactive element by at least one property related to the user interface, wherein a type of the digital visual representation is indicative of said property.

4. The method of claim 1, wherein the first interactive element is associated with the second interactive element by at least one property related to the user interface, wherein said property corresponds to at least one of (i) or (ii) or (iii):
(i) a position of the first interactive element and a position of the second interactive element meet a proximity criterion;
(ii) a content associated with the first interactive element and a content associated with the second interactive element are linked;
(iii) there is a required order of interaction between the first interactive element and the second interactive element.

5. The method of claim 1, wherein the first interactive element is an input window, and the second interactive element is a clickable element, wherein interaction with the first interactive element includes text input and valid user interaction includes input of text that complies with a certain condition.

6. The method of claim 1, wherein the first interactive element is a first input window enabling text input, and the second interactive element is a second input window enabling text input, wherein valid user interaction with the first interactive element includes input of text that complies with a certain condition.

7. The method of claim 1, wherein the valid user interaction with the first interactive element is detected automatically as the user is providing a text input, without requiring the user to interact with a clickable element after performing said valid user interaction.

8. The method of claim 1, wherein display of the digital visual representation is triggered immediately after detecting the valid user interaction with the first interactive element.

9. The method of claim 1, wherein the digital visual representation includes a visual animation which is characterized, at least partially, by a directional motion along a direction which depends on a position of the second interactive element relative to the first interactive element on the user interface.

10. The method of claim 9, comprising dynamically determining the position of the second interactive element with respect to the first interactive element, and adapting the direction of the digital visual representation accordingly.

11. The method of claim 9, wherein dynamically determining the position of the second interactive element with respect to the first interactive element, and adapting the direction of the digital visual representation accordingly, is performed responsive to an event that triggers the change of the position of the second interactive element with respect to the first interactive element.

12. The method of claim 1, comprising, responsive to detecting valid user interaction with the first interactive element, switching the second interactive element from an inactive state to an active state, wherein the switching occurs after an end of the display of the digital visual representation, wherein:
in the active state of the second interactive element, a user interaction with the second interactive element, comprising at least one of an input or a click, is allowed, and,
in the inactive state of the second interactive element, said user interaction is prevented.

13. The method of claim 1, wherein, during at least part of a motion of the visual representation, said digital visual representation moves in a direction oriented from the first interactive element towards the second interactive element.

14. The method of claim 13, wherein (i) or (ii) is met:
(i) once a position of the digital visual representation reaches a certain area within the second interactive element, the digital visual representation modifies an appearance of the second interactive element;
(ii) once a position of the digital visual representation has reached a certain area within the second interactive element, the digital visual representation converges and moves over the second interactive element.

15. The method of claim 1, wherein the digital visual representation includes modifying an appearance of a contour of the first interactive element or of the second interactive element.

16. The method of claim 1, comprising maintaining a display of the digital visual representation until an interaction with the second interactive element by the user has been detected.

17. The method of claim 1, wherein, responsive to detecting valid user interaction with the first interactive element, the method comprises triggering display of a digital visual representation indicative of the second interactive element and of a third interactive element of the plurality of interactive elements, wherein both the second interactive element and the third interactive element are each associated with the first interactive element by at least one property related to the user interface,
wherein the digital visual representation is displayed on at least one of the first interactive element, or the second interactive element, or the third interactive element.

18. The method of claim 1, wherein, before display of the digital visual representation, the second interactive element is not visible in the user interface to the user, wherein triggering display of the digital visual representation comprises performing one or more changes to the graphical user interface, which provides an indication to the user of the location of the second interactive element off screen.

19. A system comprising a processor and memory circuitry (PMC), wherein, for a graphical user interface that comprises a plurality of interactive elements comprising a first interactive element and a second interactive element, the PMC is configured to execute:
responsive to detecting valid user interaction with the first interactive element, performing a modification of the graphical user interface, said performing comprising:
triggering display of a digital visual representation on at least one of the first interactive element or the second interactive element of the graphical user interface, wherein the digital visual representation provides, to a user, indication of a location in the graphical user interface of the second interactive element with which a user interaction is required, thereby providing feedback to the user while interacting with the graphical user interface.

20. A non-transitory computer readable medium comprising instructions that, when executed by a processor and memory circuitry (PMC), cause the PMC to perform operations comprising, for a graphical user interface that comprises a plurality of interactive elements comprising a first interactive element and a second interactive element:
responsive to detecting valid user interaction with the first interactive element, performing a modification of the graphical user interface, said performing comprising:
triggering display of a digital visual representation on at least one of the first interactive element or the second interactive element of the graphical user interface, wherein the digital visual representation provides, to a user, indication of a location in the graphical user interface of the second interactive element with which a user interaction is required, thereby providing feedback to the user while interacting with the graphical user interface.
